(19) United States
(12) Patent Application Publication
(10) Pub. No.: US 2026/0180722 A1
(43) Pub. Date: Jun. 25, 2026

(54) REPORTING SIDELINK HYBRID AUTOMATIC REPEAT REQUEST FEEDBACK INFORMATION

(71) Applicant: QUALCOMM Incorporated, San Diego, CA (US)

(72) Inventors: Siyi CHEN, Beijing (CN); Jing SUN, San Diego, CA (US); Xiaoxia ZHANG, San Diego, CA (US); Chih-Hao LIU, San Diego, CA (US); Changlong XU, Beijing (CN); Shaozhen GUO, Beijing (CN); Luanxia YANG, Beijing (CN)

(21) Appl. No.: 19/127,946

(22) PCT Filed: Jan. 11, 2023
(86) PCT No.: PCT/CN2023/071768

§ 371 Date: May 7, 2025

(51) Int. Cl. H04L 1/1812; H04L 5/00; H04W 72/25; H04W 92/18

(52) U.S. Cl. CPC H04L 1/1812; H04L 5/0053; H04W 72/25; H04W 92/18

(57) ABSTRACT

Various aspects of the present disclosure generally relate to wireless communication. In some aspects, a user equipment (UE) may receive first control information comprising a first sidelink hybrid automatic repeat request (HARQ) timing offset configuration indication that indicates a state of an inapplicable sidelink offset value that is not applicable for indicating a timing for transmitting sidelink HARQ feedback information. The UE may transmit a first sidelink transmission including first sidelink control information (SCI) comprising a first sidelink HARQ timing offset indication for transmission of first sidelink HARQ feedback information associated with the first sidelink transmission, the first sidelink HARQ timing offset indication comprising, based on the first sidelink HARQ timing offset configuration indication, the inapplicable sidelink offset value or an applicable sidelink offset value that is applicable for indicating a timing for transmitting sidelink HARQ feedback information. Numerous other aspects are described.

### FIELD OF THE DISCLOSURE

Aspects of the present disclosure generally relate to wireless communication and to techniques and apparatuses for reporting sidelink hybrid automatic repeat request feedback information.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a user equipment (UE) for wireless communication. The UE may include a memory and one or more processors coupled to the memory. The one or more processors may be configured to receive first control information comprising a first sidelink hybrid automatic repeat request (HARQ) timing offset configuration indication that indicates a state of an inapplicable sidelink offset value that is not applicable for indicating a timing for transmitting sidelink HARQ feedback information. The one or more processors may be configured to transmit a first sidelink transmission including first sidelink control information (SCI) comprising a first sidelink HARQ timing offset indication for transmission of first sidelink HARQ feedback information associated with the first sidelink transmission, the first sidelink HARQ timing offset indication comprising, based on the first sidelink HARQ timing offset configuration indication, the inapplicable sidelink offset value or an applicable sidelink offset value that is applicable for indicating a timing for transmitting sidelink HARQ feedback information.

Some aspects described herein relate to a network node for wireless communication. The network node may include a memory and one or more processors coupled to the memory. The one or more processors may be configured to transmit first control information comprising a first sidelink HARQ timing offset configuration indication that indicates an enabled state of an inapplicable sidelink offset value that is not applicable for indicating a timing for transmitting sidelink HARQ feedback information. The one or more processors may be configured to transmit second control information comprising a second sidelink HARQ timing offset configuration indication that indicates a disabled state of the inapplicable sidelink offset value. The one or more processors may be configured to receive, via an uplink control channel and based on the second control information, uplink HARQ feedback information comprising first sidelink HARQ feedback information associated with a first sidelink transmission and second sidelink HARQ feedback information associated with a second sidelink transmission, the uplink HARQ feedback information comprising the first sidelink HARQ feedback information based on the first control information.

Some aspects described herein relate to a UE for wireless communication. The UE may include a memory and one or more processors coupled to the memory. The one or more processors may be configured to transmit a first sidelink transmission including first SCI comprising a first sidelink HARQ timing offset indication for transmission of first sidelink HARQ feedback information associated with the first sidelink transmission, the first sidelink HARQ timing offset indication comprising, based on a feedback time period between a sidelink feedback resource associated with receipt of the first sidelink HARQ feedback information and an uplink control channel resource associated with transmission of uplink HARQ feedback information, an inapplicable sidelink offset value that is not applicable for indicating a timing for transmitting sidelink HARQ feedback information or an applicable sidelink offset value that is applicable for indicating a timing for transmitting sidelink HARQ feedback information. The one or more processors may be configured to receive the first sidelink HARQ feedback information based on the first SCI or second SCI comprising a second sidelink HARQ timing offset indication having an applicable sidelink offset value.

Some aspects described herein relate to a network node for wireless communication. The network node may include a memory and one or more processors coupled to the memory. The one or more processors may be configured to transmit, to a UE, first control information comprising an uplink HARQ timing offset indication having an applicable uplink offset value that is applicable for indicating a timing for transmitting uplink HARQ feedback information. The one or more processors may be configured to receive, from the UE and based on the first control information, uplink HARQ feedback information comprising first sidelink HARQ feedback information, the uplink HARQ feedback information comprising the first sidelink HARQ feedback information based on, first sidelink control information comprising a first sidelink HARQ timing offset indication having, based on a feedback time period between a sidelink feedback resource associated with receipt of the first sidelink HARQ feedback information and an uplink control channel resource associated with transmission of the uplink HARQ feedback information, an applicable sidelink offset value that is applicable for indicating a timing for transmitting sidelink HARQ feedback information, or second SCI comprising a second sidelink HARQ timing offset indication having an applicable sidelink offset value.

Some aspects described herein relate to a UE for wireless communication. The UE may include a memory and one or more processors coupled to the memory. The one or more processors may be configured to transmit a first sidelink transmission including first SCI comprising a first sidelink HARQ timing offset indication for transmission of first sidelink HARQ feedback information associated with a first sidelink transmission and a second sidelink HARQ timing offset indication for transmission of second sidelink HARQ feedback information associated with a second sidelink transmission, the first sidelink HARQ timing offset indication comprising an applicable sidelink offset value that is applicable for indicating a timing for transmitting sidelink HARQ feedback information, and the second sidelink HARQ timing offset indication comprising an inapplicable sidelink offset value that is not applicable for indicating a timing for transmitting sidelink HARQ feedback information. The one or more processors may be configured to receive the first sidelink HARQ feedback information. The one or more processors may be configured to transmit, via an uplink control channel, first uplink HARQ feedback information comprising the first sidelink HARQ feedback information, the first uplink HARQ feedback information further comprising a negative HARQ acknowledgment associated with the second sidelink HARQ feedback information based on the UE not receiving the second sidelink HARQ feedback information prior to occurrence of a first time associated with a first uplink control channel resource allocated for transmission of the first uplink HARQ feedback information.

Some aspects described herein relate to a network node for wireless communication. The network node may include a memory and one or more processors coupled to the memory. The one or more processors may be configured to transmit, to a UE, first control information indicating a first uplink control channel resource associated with transmission of first uplink HARQ feedback information. The one or more processors may be configured to receive, from the UE, first uplink HARQ feedback information comprising first sidelink HARQ feedback information associated with a first sidelink transmission, the first uplink HARQ feedback information further comprising a negative HARQ acknowledgment associated with second sidelink HARQ feedback information associated with a second sidelink transmission and based on the UE not receiving the second sidelink HARQ feedback information prior to occurrence of a first time associated with a first uplink control channel resource allocated for transmission of the first uplink HARQ feedback information.

Some aspects described herein relate to a UE for wireless communication. The UE may include a memory and one or more processors coupled to the memory. The one or more processors may be configured to transmit a first sidelink transmission including first SCI comprising a first sidelink HARQ timing offset indication for transmission of first sidelink HARQ feedback information associated with at least one sidelink transmission, the first sidelink HARQ timing offset indication comprising an inapplicable sidelink offset value that is not applicable for indicating a timing for transmitting sidelink HARQ feedback information or an applicable sidelink offset value that is applicable for indicating a timing for transmitting sidelink HARQ feedback information. The one or more processors may be configured to receive the first sidelink HARQ feedback information. The one or more processors may be configured to transmit, via an uplink control channel, first uplink HARQ feedback information comprising the first sidelink HARQ feedback information, the first uplink HARQ feedback information comprising a HARQ-acknowledgment (HARQ-ACK) codebook including at least one applicability indication associated with at least one HARQ-ACK of the first sidelink HARQ feedback information, the at least one applicability indication indicating whether the at least one HARQ-ACK is associated with the applicable sidelink offset value or the inapplicable sidelink offset value.

Some aspects described herein relate to a network node for wireless communication. The network node may include a memory and one or more processors coupled to the memory. The one or more processors may be configured to receive, via an uplink control channel, first uplink HARQ feedback information comprising first sidelink HARQ feedback information associated with at least one sidelink transmission, the first uplink HARQ feedback information comprising a HARQ-ACK codebook including at least one applicability indication associated with at least one HARQ-ACK of the first sidelink HARQ feedback information, the at least one applicability indication indicating whether the at least one HARQ-ACK is associated with an inapplicable sidelink offset value that is not applicable for indicating a timing for transmitting sidelink HARQ feedback information or an applicable sidelink offset value that is applicable for indicating a timing for transmitting sidelink HARQ feedback information. The one or more processors may be configured to transmit a resource allocation comprising an allocation of retransmission resources based on the at least one applicability indication.

Some aspects described herein relate to a method of wireless communication performed by a UE. The method may include receiving first control information comprising a first sidelink HARQ timing offset configuration indication that indicates a state of an inapplicable sidelink offset value that is not applicable for indicating a timing for transmitting sidelink HARQ feedback information. The method may include transmitting a first sidelink transmission including first SCI comprising a first sidelink HARQ timing offset indication for transmission of first sidelink HARQ feedback information associated with the first sidelink transmission, the first sidelink HARQ timing offset indication comprising, based on the first sidelink HARQ timing offset configuration indication, the inapplicable sidelink offset value or an applicable sidelink offset value that is applicable for indicating a timing for transmitting sidelink HARQ feedback information.

Some aspects described herein relate to a method of wireless communication performed by a network node. The method may include transmitting first control information comprising a first sidelink HARQ timing offset configuration indication that indicates an enabled state of an inapplicable sidelink offset value that is not applicable for indicating a timing for transmitting sidelink HARQ feedback information. The method may include transmitting second control information comprising a second sidelink HARQ timing offset configuration indication that indicates a disabled state of the inapplicable sidelink offset value. The method may include receiving, via an uplink control channel and based on the second control information, uplink HARQ feedback information comprising first sidelink HARQ feedback information associated with a first sidelink transmission and second sidelink HARQ feedback information associated with a second sidelink transmission, the uplink HARQ feedback information comprising the first sidelink HARQ feedback information based on the first control information.

Some aspects described herein relate to a method of wireless communication performed by a UE. The method may include transmitting a first sidelink transmission including first SCI comprising a first sidelink HARQ timing offset indication for transmission of first sidelink HARQ feedback information associated with the first sidelink transmission, the first sidelink HARQ timing offset indication comprising, based on a feedback time period between a sidelink feedback resource associated with receipt of the first sidelink HARQ feedback information and an uplink control channel resource associated with transmission of uplink HARQ feedback information, an inapplicable sidelink offset value that is not applicable for indicating a timing for transmitting sidelink HARQ feedback information or an applicable sidelink offset value that is applicable for indicating a timing for transmitting sidelink HARQ feedback information. The method may include receiving the first sidelink HARQ feedback information based on the first SCI or second SCI comprising a second sidelink HARQ timing offset indication having an applicable sidelink offset value.

Some aspects described herein relate to a method of wireless communication performed by a network node. The method may include transmitting, to a UE, first control information comprising an uplink HARQ timing offset indication having an applicable uplink offset value that is applicable for indicating a timing for transmitting uplink HARQ feedback information. The method may include receiving, from the UE and based on the first control information, uplink HARQ feedback information comprising first sidelink HARQ feedback information, the uplink HARQ feedback information comprising the first sidelink HARQ feedback information based on, first sidelink control information comprising a first sidelink HARQ timing offset indication having, based on a feedback time period between a sidelink feedback resource associated with receipt of the first sidelink HARQ feedback information and an uplink control channel resource associated with transmission of the uplink HARQ feedback information, an applicable sidelink offset value that is applicable for indicating a timing for transmitting sidelink HARQ feedback information, or second SCI comprising a second sidelink HARQ timing offset indication having an applicable sidelink offset value.

Some aspects described herein relate to a method of wireless communication performed by a UE. The method may include transmitting a first sidelink transmission including first SCI comprising a first sidelink HARQ timing offset indication for transmission of first sidelink HARQ feedback information associated with a first sidelink transmission and a second sidelink HARQ timing offset indication for transmission of second sidelink HARQ feedback information associated with a second sidelink transmission, the first sidelink HARQ timing offset indication comprising an applicable sidelink offset value that is applicable for indicating a timing for transmitting sidelink HARQ feedback information, and the second sidelink HARQ timing offset indication comprising an inapplicable sidelink offset value that is not applicable for indicating a timing for transmitting sidelink HARQ feedback information. The method may include receiving the first sidelink HARQ feedback information. The method may include transmitting, via an uplink control channel, first uplink HARQ feedback information comprising the first sidelink HARQ feedback information, the first uplink HARQ feedback information further comprising a negative HARQ acknowledgment associated with the second sidelink HARQ feedback information based on the UE not receiving the second sidelink HARQ feedback information prior to occurrence of a first time associated with a first uplink control channel resource allocated for transmission of the first uplink HARQ feedback information.

Some aspects described herein relate to a method of wireless communication performed by a network node. The method may include transmitting, to a UE, first control information indicating a first uplink control channel resource associated with transmission of first uplink HARQ feedback information. The method may include receiving, from the UE, first uplink HARQ feedback information comprising first sidelink HARQ feedback information associated with a first sidelink transmission, the first uplink HARQ feedback information further comprising a negative HARQ acknowledgment associated with second sidelink HARQ feedback information associated with a second sidelink transmission and based on the UE not receiving the second sidelink HARQ feedback information prior to occurrence of a first time associated with a first uplink control channel resource allocated for transmission of the first uplink HARQ feedback information.

Some aspects described herein relate to a method of wireless communication performed by a UE. The method may include transmitting a first sidelink transmission including first SCI comprising a first sidelink HARQ timing offset indication for transmission of first sidelink HARQ feedback information associated with at least one sidelink transmission, the first sidelink HARQ timing offset indication comprising an inapplicable sidelink offset value that is not applicable for indicating a timing for transmitting sidelink HARQ feedback information or an applicable sidelink offset value that is applicable for indicating a timing for transmitting sidelink HARQ feedback information. The method may include receiving the first sidelink HARQ feedback information. The method may include transmitting, via an uplink control channel, first uplink HARQ feedback information comprising the first sidelink HARQ feedback information, the first uplink HARQ feedback information comprising a HARQ-ACK codebook including at least one applicability indication associated with at least one HARQ-ACK of the first sidelink HARQ feedback information, the at least one applicability indication indicating whether the at least one HARQ-ACK is associated with the applicable sidelink offset value or the inapplicable sidelink offset value.

Some aspects described herein relate to a method of wireless communication performed by a network node. The method may include receiving, via an uplink control channel, first uplink HARQ feedback information comprising first sidelink HARQ feedback information associated with at least one sidelink transmission, the first uplink HARQ feedback information comprising a HARQ-ACK codebook including at least one applicability indication associated with at least one HARQ-ACK of the first sidelink HARQ feedback information, the at least one applicability indication indicating whether the at least one HARQ-ACK is associated with an inapplicable sidelink offset value that is not applicable for indicating a timing for transmitting sidelink HARQ feedback information or an applicable sidelink offset value that is applicable for indicating a timing for transmitting sidelink HARQ feedback information. The method may include transmitting a resource allocation comprising an allocation of retransmission resources based on the at least one applicability indication.

Some aspects described herein relate to a non-transitory computer-readable medium that stores a set of instructions for wireless communication by a UE. The set of instructions, when executed by one or more processors of the UE, may cause the UE to receive first control information comprising a first sidelink HARQ timing offset configuration indication that indicates a state of an inapplicable sidelink offset value that is not applicable for indicating a timing for transmitting sidelink HARQ feedback information. The set of instructions, when executed by one or more processors of the UE, may cause the UE to transmit a first sidelink transmission including first SCI comprising a first sidelink HARQ timing offset indication for transmission of first sidelink HARQ feedback information associated with the first sidelink transmission, the first sidelink HARQ timing offset indication comprising, based on the first sidelink HARQ timing offset configuration indication, the inapplicable sidelink offset value or an applicable sidelink offset value that is applicable for indicating a timing for transmitting sidelink HARQ feedback information.

Some aspects described herein relate to a non-transitory computer-readable medium that stores a set of instructions for wireless communication by a network node. The set of instructions, when executed by one or more processors of the network node, may cause the network node to transmit first control information comprising a first sidelink HARQ timing offset configuration indication that indicates an enabled state of an inapplicable sidelink offset value that is not applicable for indicating a timing for transmitting sidelink HARQ feedback information. The set of instructions, when executed by one or more processors of the network node, may cause the network node to transmit second control information comprising a second sidelink HARQ timing offset configuration indication that indicates a disabled state of the inapplicable sidelink offset value. The set of instructions, when executed by one or more processors of the network node, may cause the network node to receive, via an uplink control channel and based on the second control information, uplink HARQ feedback information comprising first sidelink HARQ feedback information associated with a first sidelink transmission and second sidelink HARQ feedback information associated with a second sidelink transmission, the uplink HARQ feedback information comprising the first sidelink HARQ feedback information based on the first control information.

Some aspects described herein relate to a non-transitory computer-readable medium that stores a set of instructions for wireless communication by an UE. The set of instructions, when executed by one or more processors of the UE, may cause the UE to transmit a first sidelink transmission including first SCI comprising a first sidelink HARQ timing offset indication for transmission of first sidelink HARQ feedback information associated with the first sidelink transmission, the first sidelink HARQ timing offset indication comprising, based on a feedback time period between a sidelink feedback resource associated with receipt of the first sidelink HARQ feedback information and an uplink control channel resource associated with transmission of uplink HARQ feedback information, an inapplicable sidelink offset value that is not applicable for indicating a timing for transmitting sidelink HARQ feedback information or an applicable sidelink offset value that is applicable for indicating a timing for transmitting sidelink HARQ feedback information. The set of instructions, when executed by one or more processors of the UE, may cause the UE to receive the first sidelink HARQ feedback information based on the first SCI or second SCI comprising a second sidelink HARQ timing offset indication having an applicable sidelink offset value.

Some aspects described herein relate to a non-transitory computer-readable medium that stores a set of instructions for wireless communication by a network node. The set of instructions, when executed by one or more processors of the network node, may cause the network node to transmit, to a UE, first control information comprising an uplink HARQ timing offset indication having an applicable uplink offset value that is applicable for indicating a timing for transmitting uplink HARQ feedback information. The set of instructions, when executed by one or more processors of the network node, may cause the network node to receive, from the UE and based on the first control information, uplink HARQ feedback information comprising first sidelink HARQ feedback information, the uplink HARQ feedback information comprising the first sidelink HARQ feedback information based on, first sidelink control information comprising a first sidelink HARQ timing offset indication having, based on a feedback time period between a sidelink feedback resource associated with receipt of the first sidelink HARQ feedback information and an uplink control channel resource associated with transmission of the uplink HARQ feedback information, an applicable sidelink offset value that is applicable for indicating a timing for transmitting sidelink HARQ feedback information, or second SCI comprising a second sidelink HARQ timing offset indication having an applicable sidelink offset value.

Some aspects described herein relate to a non-transitory computer-readable medium that stores a set of instructions for wireless communication by an UE. The set of instructions, when executed by one or more processors of the UE, may cause the UE to transmit a first sidelink transmission including first SCI comprising a first sidelink HARQ timing offset indication for transmission of first sidelink HARQ feedback information associated with a first sidelink transmission and a second sidelink HARQ timing offset indication for transmission of second sidelink HARQ feedback information associated with a second sidelink transmission, the first sidelink HARQ timing offset indication comprising an applicable sidelink offset value that is applicable for indicating a timing for transmitting sidelink HARQ feedback information, and the second sidelink HARQ timing offset indication comprising an inapplicable sidelink offset value that is not applicable for indicating a timing for transmitting sidelink HARQ feedback information. The set of instructions, when executed by one or more processors of the UE, may cause the UE to receive the first sidelink HARQ feedback information. The set of instructions, when executed by one or more processors of the UE, may cause the UE to transmit, via an uplink control channel, first uplink HARQ feedback information comprising the first sidelink HARQ feedback information, the first uplink HARQ feedback information further comprising a negative HARQ acknowledgment associated with the second sidelink HARQ feedback information based on the UE not receiving the second sidelink HARQ feedback information prior to occurrence of a first time associated with a first uplink control channel resource allocated for transmission of the first uplink HARQ feedback information.

Some aspects described herein relate to a non-transitory computer-readable medium that stores a set of instructions for wireless communication by a network node. The set of instructions, when executed by one or more processors of the network node, may cause the network node to transmit, to a UE, first control information indicating a first uplink control channel resource associated with transmission of first uplink HARQ feedback information. The set of instructions, when executed by one or more processors of the network node, may cause the network node to receive, from the UE, first uplink HARQ feedback information comprising first sidelink HARQ feedback information associated with a first sidelink transmission, the first uplink HARQ feedback information further comprising a negative HARQ acknowledgment associated with second sidelink HARQ feedback information associated with a second sidelink transmission and based on the UE not receiving the second sidelink HARQ feedback information prior to occurrence of a first time associated with a first uplink control channel resource allocated for transmission of the first uplink HARQ feedback information.

Some aspects described herein relate to a non-transitory computer-readable medium that stores a set of instructions for wireless communication by an UE. The set of instructions, when executed by one or more processors of the UE, may cause the UE to transmit a first sidelink transmission including first SCI comprising a first sidelink HARQ timing offset indication for transmission of first sidelink HARQ feedback information associated with at least one sidelink transmission, the first sidelink HARQ timing offset indication comprising an inapplicable sidelink offset value that is not applicable for indicating a timing for transmitting sidelink HARQ feedback information or an applicable sidelink offset value that is applicable for indicating a timing for transmitting sidelink HARQ feedback information. The set of instructions, when executed by one or more processors of the UE, may cause the UE to receive the first sidelink HARQ feedback information. The set of instructions, when executed by one or more processors of the UE, may cause the UE to transmit, via an uplink control channel, first uplink HARQ feedback information comprising the first sidelink HARQ feedback information, the first uplink HARQ feedback information comprising a HARQ-ACK codebook including at least one applicability indication associated with at least one HARQ-ACK of the first sidelink HARQ feedback information, the at least one applicability indication indicating whether the at least one HARQ-ACK is associated with the applicable sidelink offset value or the inapplicable sidelink offset value.

Some aspects described herein relate to a non-transitory computer-readable medium that stores a set of instructions for wireless communication by a network node. The set of instructions, when executed by one or more processors of the network node, may cause the network node to receive, via an uplink control channel, first uplink HARQ feedback information comprising first sidelink HARQ feedback information associated with at least one sidelink transmission, the first uplink HARQ feedback information comprising a HARQ-ACK codebook including at least one applicability indication associated with at least one HARQ-ACK of the first sidelink HARQ feedback information, the at least one applicability indication indicating whether the at least one HARQ-ACK is associated with an inapplicable sidelink offset value that is not applicable for indicating a timing for transmitting sidelink HARQ feedback information or an applicable sidelink offset value that is applicable for indicating a timing for transmitting sidelink HARQ feedback information. The set of instructions, when executed by one or more processors of the network node, may cause the network node to transmit a resource allocation comprising an allocation of retransmission resources based on the at least one applicability indication.

Some aspects described herein relate to an apparatus for wireless communication. The apparatus may include means for receiving first control information comprising a first sidelink HARQ timing offset configuration indication that indicates a state of an inapplicable sidelink offset value that is not applicable for indicating a timing for transmitting sidelink HARQ feedback information. The apparatus may include means for transmitting a first sidelink transmission including first SCI comprising a first sidelink HARQ timing offset indication for transmission of first sidelink HARQ feedback information associated with the first sidelink transmission, the first sidelink HARQ timing offset indication comprising, based on the first sidelink HARQ timing offset configuration indication, the inapplicable sidelink offset value or an applicable sidelink offset value that is applicable for indicating a timing for transmitting sidelink HARQ feedback information.

Some aspects described herein relate to an apparatus for wireless communication. The apparatus may include means for transmitting first control information comprising a first sidelink HARQ timing offset configuration indication that indicates an enabled state of an inapplicable sidelink offset value that is not applicable for indicating a timing for transmitting sidelink HARQ feedback information. The apparatus may include means for transmitting second control information comprising a second sidelink HARQ timing offset configuration indication that indicates a disabled state of the inapplicable sidelink offset value. The apparatus may include means for receiving, via an uplink control channel and based on the second control information, uplink HARQ feedback information comprising first sidelink HARQ feedback information associated with a first sidelink transmission and second sidelink HARQ feedback information associated with a second sidelink transmission, the uplink HARQ feedback information comprising the first sidelink HARQ feedback information based on the first control information.

Some aspects described herein relate to an apparatus for wireless communication. The apparatus may include means for transmitting a first sidelink transmission including first SCI comprising a first sidelink HARQ timing offset indication for transmission of first sidelink HARQ feedback information associated with the first sidelink transmission, the first sidelink HARQ timing offset indication comprising, based on a feedback time period between a sidelink feedback resource associated with receipt of the first sidelink HARQ feedback information and an uplink control channel resource associated with transmission of uplink HARQ feedback information, an inapplicable sidelink offset value that is not applicable for indicating a timing for transmitting sidelink HARQ feedback information or an applicable sidelink offset value that is applicable for indicating a timing for transmitting sidelink HARQ feedback information. The apparatus may include means for receiving the first sidelink HARQ feedback information based on the first SCI or second SCI comprising a second sidelink HARQ timing offset indication having an applicable sidelink offset value.

Some aspects described herein relate to an apparatus for wireless communication. The apparatus may include means for transmitting, to a UE, first control information comprising an uplink HARQ timing offset indication having an applicable uplink offset value that is applicable for indicating a timing for transmitting uplink HARQ feedback information. The apparatus may include means for receiving, from the UE and based on the first control information, uplink HARQ feedback information comprising first sidelink HARQ feedback information, the uplink HARQ feedback information comprising the first sidelink HARQ feedback information based on, first sidelink control information comprising a first sidelink HARQ timing offset indication having, based on a feedback time period between a sidelink feedback resource associated with receipt of the first sidelink HARQ feedback information and an uplink control channel resource associated with transmission of the uplink HARQ feedback information, an applicable sidelink offset value that is applicable for indicating a timing for transmitting sidelink HARQ feedback information, or second SCI comprising a second sidelink HARQ timing offset indication having an applicable sidelink offset value.

Some aspects described herein relate to an apparatus for wireless communication. The apparatus may include means for transmitting a first sidelink transmission including first SCI comprising a first sidelink HARQ timing offset indication for transmission of first sidelink HARQ feedback information associated with a first sidelink transmission and a second sidelink HARQ timing offset indication for transmission of second sidelink HARQ feedback information associated with a second sidelink transmission, the first sidelink HARQ timing offset indication comprising an applicable sidelink offset value that is applicable for indicating a timing for transmitting sidelink HARQ feedback information, and the second sidelink HARQ timing offset indication comprising an inapplicable sidelink offset value that is not applicable for indicating a timing for transmitting sidelink HARQ feedback information. The apparatus may include means for receiving the first sidelink HARQ feedback information. The apparatus may include means for transmitting, via an uplink control channel, first uplink HARQ feedback information comprising the first sidelink HARQ feedback information, the first uplink HARQ feedback information further comprising a negative HARQ acknowledgment associated with the second sidelink HARQ feedback information based on the apparatus not receiving the second sidelink HARQ feedback information prior to occurrence of a first time associated with a first uplink control channel resource allocated for transmission of the first uplink HARQ feedback information.

Some aspects described herein relate to an apparatus for wireless communication. The apparatus may include means for transmitting, to a UE, first control information indicating a first uplink control channel resource associated with transmission of first uplink HARQ feedback information. The apparatus may include means for receiving, from the UE, first uplink HARQ feedback information comprising first sidelink HARQ feedback information associated with a first sidelink transmission, the first uplink HARQ feedback information further comprising a negative HARQ acknowledgment associated with second sidelink HARQ feedback information associated with a second sidelink transmission and based on the UE not receiving the second sidelink HARQ feedback information prior to occurrence of a first time associated with a first uplink control channel resource allocated for transmission of the first uplink HARQ feedback information.

Some aspects described herein relate to an apparatus for wireless communication. The apparatus may include means for transmitting a first sidelink transmission including first SCI comprising a first sidelink HARQ timing offset indication for transmission of first sidelink HARQ feedback information associated with at least one sidelink transmission, the first sidelink HARQ timing offset indication comprising an inapplicable sidelink offset value that is not applicable for indicating a timing for transmitting sidelink HARQ feedback information or an applicable sidelink offset value that is applicable for indicating a timing for transmitting sidelink HARQ feedback information. The apparatus may include means for receiving the first sidelink HARQ feedback information. The apparatus may include means for transmitting, via an uplink control channel, first uplink HARQ feedback information comprising the first sidelink HARQ feedback information, the first uplink HARQ feedback information comprising a HARQ-ACK codebook including at least one applicability indication associated with at least one HARQ-ACK of the first sidelink HARQ feedback information, the at least one applicability indication indicating whether the at least one HARQ-ACK is associated with the applicable sidelink offset value or the inapplicable sidelink offset value.

Some aspects described herein relate to an apparatus for wireless communication. The apparatus may include means for receiving, via an uplink control channel, first uplink HARQ feedback information comprising first sidelink HARQ feedback information associated with at least one sidelink transmission, the first uplink HARQ feedback information comprising a HARQ-ACK codebook including at least one applicability indication associated with at least one HARQ-ACK of the first sidelink HARQ feedback information, the at least one applicability indication indicating whether the at least one HARQ-ACK is associated with an inapplicable sidelink offset value that is not applicable for indicating a timing for transmitting sidelink HARQ feedback information or an applicable sidelink offset value that is applicable for indicating a timing for transmitting sidelink HARQ feedback information. The apparatus may include means for transmitting a resource allocation comprising an allocation of retransmission resources based on the at least one applicability indication.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of sidelink communications, in accordance with the present disclosure.

FIG. 5 is a diagram illustrating an example associated with sidelink hybrid automatic repeat request (HARQ) reporting and uplink HARQ reporting, in accordance with the present disclosure.

FIG. 6 is a diagram illustrating an example of dynamic HARQ timing for transmitting feedback information, in accordance with the present disclosure.

FIG. 7A is a diagram illustrating an example associated with reporting sidelink HARQ feedback information, in accordance with the present disclosure.

FIG. 7B is a diagram illustrating another example associated with reporting sidelink HARQ feedback information, in accordance with the present disclosure.

FIG. 7C is a diagram illustrating another example associated with reporting sidelink HARQ feedback information, in accordance with the present disclosure.

FIG. 7D is a diagram illustrating another example associated with reporting sidelink HARQ feedback information, in accordance with the present disclosure.

FIG. 8 is a diagram illustrating an example process performed, for example, by a UE, in accordance with the present disclosure.

FIG. 9 is a diagram illustrating an example process performed, for example, by a network node, in accordance with the present disclosure.

FIG. 10 is a diagram illustrating an example process performed, for example, by a UE, in accordance with the present disclosure.

FIG. 11 is a diagram illustrating an example process performed, for example, by a network node, in accordance with the present disclosure.

FIG. 12 is a diagram illustrating an example process performed, for example, by a UE, in accordance with the present disclosure.

FIG. 13 is a diagram illustrating an example process performed, for example, by a network node, in accordance with the present disclosure.

FIG. 14 is a diagram illustrating an example process performed, for example, by a UE, in accordance with the present disclosure.

FIG. 15 is a diagram illustrating an example process performed, for example, by a network node, in accordance with the present disclosure.

FIG. 16 is a diagram of an example apparatus for wireless communication, in accordance with the present disclosure.

FIG. 17 is a diagram of an example apparatus for wireless communication, in accordance with the present disclosure.

### DETAILED DESCRIPTION

A user equipment (UE) may communicate with another UE via a sidelink. In some cases, a UE that receives a sidelink transmission from another UE can report sidelink hybrid automatic repeat request (HARQ) feedback information to the transmitting UE to indicate whether the sidelink was able to be received and decoded. The transmitting UE may report the sidelink HARQ feedback information to a network node. In some cases, the network node can allocate the uplink resources for reporting the HARQ feedback information. In some sidelink modes, the HARQ feedback information can be transmitted in the physical uplink control channel (PUCCH) resources configured after the physical sidelink feedback channel (PSFCH) resources associated with the last allocated resource in a dynamic grant or in each configured grant period. Since the PSFCH transmission timing can be defined to be the first slot with a PSFCH resource after a configured (or pre-configured) number, K, of slots after the physical sidelink shared channel (PSSCH), the network node can set a correct timing for PSFCH to PUCCH feedback to ensure all the HARQ-ACK feedback can be reported.

However, in some sidelink scenarios, HARQ feedback reporting can be configured for inapplicable offset values of sidelink HARQ timing offset K1. An inapplicable offset value of a HARQ feedback information timing offset is a value that is not applicable for indicating a timing for transmitting HARQ feedback information. Conversely, an applicable offset value is a value that is applicable for indicating a timing for transmitting HARQ feedback information. Introducing dynamic HARQ feedback offsets that support inapplicable offset values into Mode 1 sidelink can result in an inconsistent understanding between the UE and the network node with respect to uplink HARQ feedback timing. As a result, some uplink HARQ feedback information may be missed by the network node, which may negatively impact network communications due to inappropriate and/or insufficient allocation of sidelink resources.

Some aspects of the techniques and apparatuses described herein may include a timing scheme for reporting sidelink HARQ feedback information to a network node. In some aspects, the use of inapplicable offset values may be indicated by the network node and, in some other aspects, the transmitter UE may independently determine whether to use inapplicable offset values. For example, in some aspects, a network node may provide, to a UE, control information that indicates a state (e.g., allowed or disallowed) of an inapplicable sidelink offset value associated with allocated sidelink resources. In some aspects, the control information may indicate an applicable value or an inapplicable value of an uplink HARQ offset indication associated with timing for transmitting uplink HARQ feedback information. In this way, some aspects may facilitate network control of whether inapplicable HARQ timing offset values are used, and, thus, the network node and the UE may both have the same feedback timing information, thereby mitigating the risk of missed uplink HARQ feedback information transmissions, inappropriate sidelink resource allocations, and/or inefficient sidelink resource allocations.

In some aspects, a UE may determine whether to use inapplicable sidelink HARQ timing offset indication values. In some aspects, the UE may determine whether to use an inapplicable sidelink HARQ timing offset indication value based on a feedback time period between a sidelink feedback resource associated with receipt of the first sidelink HARQ feedback information and an uplink control channel resource associated with transmission of the uplink HARQ feedback information. In some aspects, the UE may determine whether to use inapplicable sidelink HARQ timing offset indication values, and for uplink HARQ feedback reporting, the UE may generate a NACK for a HARQ process associated with a sidelink transmission if the UE has not received sidelink HARQ feedback information associated with the sidelink transmission. Before the UE receives sidelink HARQ feedback information associated with an inapplicable sidelink HARQ timing offset indication value, the UE may refrain from performing retransmission associated with the corresponding HARQ processes. In some aspects, the UE may determine whether to use inapplicable sidelink HARQ timing offset indication values, and for uplink HARQ feedback reporting, the UE may include indications in the HARQ-ACK codebook that indicate whether each ACK/NACK corresponds to an applicable sidelink HARQ timing offset indication value or an inapplicable sidelink HARQ timing offset indication value. In this way, the uplink feedback timing information may be independent of the sidelink feedback timing from the perspective of the network node, thereby mitigating the risk of missed uplink HARQ feedback information transmissions, inappropriate sidelink resource allocations, and/or inefficient sidelink resource allocations.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Aspects and examples generally include a method, apparatus, network node, system, computer program product, non-transitory computer-readable medium, user equipment, base station, wireless communication device, and/or processing system as described or substantially described herein with reference to and as illustrated by the drawings and specification.

This disclosure may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, are better understood from the following description when considered in connection with the accompanying figures. Each of the figures is provided for the purposes of illustration and description, and not as a definition of the limits of the claims.

While aspects are described in the present disclosure by illustration to some examples, such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component-based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). Aspects described herein may be practiced in a wide variety of devices, components, systems, distributed arrangements, and/or end-user devices of varying size, shape, and constitution.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

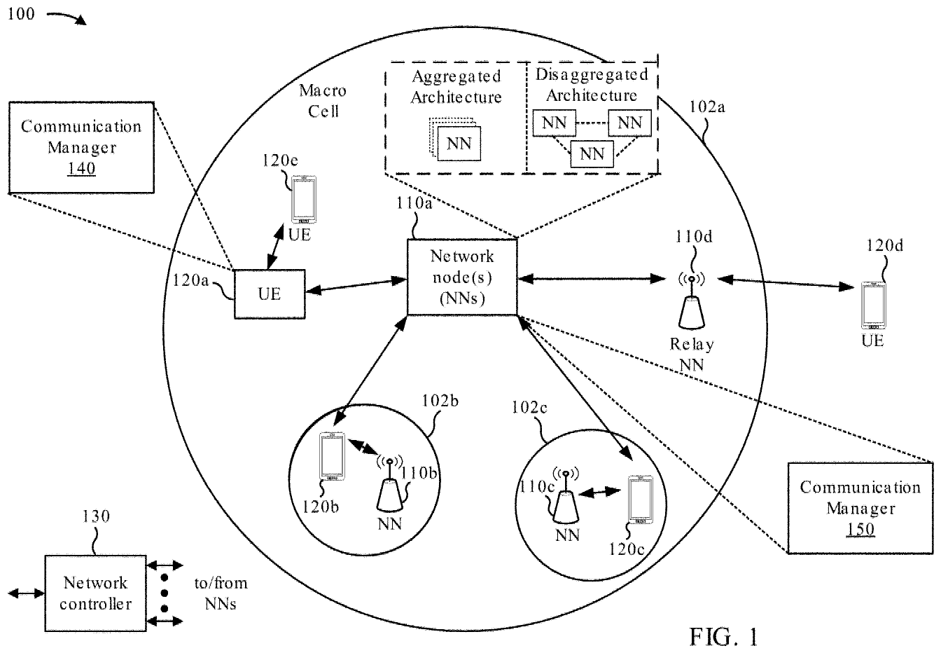

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive first control information comprising a first sidelink HARQ timing offset configuration indication that indicates a state of an inapplicable sidelink offset value that is not applicable for indicating a timing for transmitting sidelink HARQ feedback information; and transmit a first sidelink transmission including first sidelink control information (SCI) comprising a first sidelink HARQ timing offset indication for transmission of first sidelink HARQ feedback information associated with the first sidelink transmission, the first sidelink HARQ timing offset indication comprising, based on the first sidelink HARQ timing offset configuration indication, the inapplicable sidelink offset value or an applicable sidelink offset value that is applicable for indicating a timing for transmitting sidelink HARQ feedback information.

In some aspects, the communication manager 140 may transmit a first sidelink transmission including first SCI comprising a first sidelink HARQ timing offset indication for transmission of first sidelink HARQ feedback information associated with the first sidelink transmission, the first sidelink HARQ timing offset indication comprising, based on a feedback time period between a sidelink feedback resource associated with receipt of the first sidelink HARQ feedback information and an uplink control channel resource associated with transmission of uplink HARQ feedback information, an inapplicable sidelink offset value that is not applicable for indicating a timing for transmitting sidelink HARQ feedback information or an applicable sidelink offset value that is applicable for indicating a timing for transmitting sidelink HARQ feedback information; and receive the first sidelink HARQ feedback information based on the first SCI or second SCI comprising a second sidelink HARQ timing offset indication having an applicable sidelink offset value.

In some aspects, the communication manager 140 may transmit a first sidelink transmission including first SCI comprising a first sidelink HARQ timing offset indication for transmission of first sidelink HARQ feedback information associated with a first sidelink transmission and a second sidelink HARQ timing offset indication for transmission of second sidelink HARQ feedback information associated with a second sidelink transmission, the first sidelink HARQ timing offset indication comprising an applicable sidelink offset value that is applicable for indicating a timing for transmitting sidelink HARQ feedback information, and the second sidelink HARQ timing offset indication comprising an inapplicable sidelink offset value that is not applicable for indicating a timing for transmitting sidelink HARQ feedback information; receive the first sidelink HARQ feedback information; and transmit, via an uplink control channel, first uplink HARQ feedback information comprising the first sidelink HARQ feedback information, the first uplink HARQ feedback information further comprising a negative HARQ acknowledgment associated with the second sidelink HARQ feedback information based on the UE not receiving the second sidelink HARQ feedback information prior to occurrence of a first time associated with a first uplink control channel resource allocated for transmission of the first uplink HARQ feedback information.

In some aspects, the communication manager 140 may transmit a first sidelink transmission including first SCI comprising a first sidelink HARQ timing offset indication for transmission of first sidelink HARQ feedback information associated with at least one sidelink transmission, the first sidelink HARQ timing offset indication comprising an inapplicable sidelink offset value that is not applicable for indicating a timing for transmitting sidelink HARQ feedback information or an applicable sidelink offset value that is applicable for indicating a timing for transmitting sidelink HARQ feedback information; receive the first sidelink HARQ feedback information; and transmit, via an uplink control channel, first uplink HARQ feedback information comprising the first sidelink HARQ feedback information, the first uplink HARQ feedback information comprising a HARQ-acknowledgment (HARQ-ACK) codebook including at least one applicability indication associated with at least one HARQ-ACK of the first sidelink HARQ feedback information, the at least one applicability indication indicating whether the at least one HARQ-ACK is associated with the applicable sidelink offset value or the inapplicable sidelink offset value. Additionally, or alternatively, the communication manager 140 may perform one or more other operations described herein.

In some aspects, the network node 110 may include a communication manager 150. As described in more detail elsewhere herein, the communication manager 150 may transmit first control information comprising a first sidelink HARQ timing offset configuration indication that indicates an enabled state of an inapplicable sidelink offset value that is not applicable for indicating a timing for transmitting sidelink HARQ feedback information; transmit second control information comprising a second sidelink HARQ timing offset configuration indication that indicates a disabled state of the inapplicable sidelink offset value; and receive, via an uplink control channel and based on the second control information, uplink HARQ feedback information comprising first sidelink HARQ feedback information associated with a first sidelink transmission and second sidelink HARQ feedback information associated with a second sidelink transmission, the uplink HARQ feedback information comprising the first sidelink HARQ feedback information based on the first control information.

In some aspects, the communication manager 150 may transmit, to a UE, first control information comprising an uplink HARQ timing offset indication having an applicable uplink offset value that is applicable for indicating a timing for transmitting uplink HARQ feedback information; and receive, from the UE and based on the first control information, uplink HARQ feedback information comprising first sidelink HARQ feedback information, the uplink HARQ feedback information comprising the first sidelink HARQ feedback information based on: first sidelink control information comprising a first sidelink HARQ timing offset indication having, based on a feedback time period between a sidelink feedback resource associated with receipt of the first sidelink HARQ feedback information and an uplink control channel resource associated with transmission of the uplink HARQ feedback information, an applicable sidelink offset value that is applicable for indicating a timing for transmitting sidelink HARQ feedback information, or second SCI comprising a second sidelink HARQ timing offset indication having an applicable sidelink offset value.

In some aspects, the communication manager 150 may transmit, to a UE, first control information indicating a first uplink control channel resource associated with transmission of first uplink HARQ feedback information; and receive, from the UE, first uplink HARQ feedback information comprising first sidelink HARQ feedback information associated with a first sidelink transmission, the first uplink HARQ feedback information further comprising a negative HARQ acknowledgment associated with second sidelink HARQ feedback information associated with a second sidelink transmission and based on the UE not receiving the second sidelink HARQ feedback information prior to occurrence of a first time associated with a first uplink control channel resource allocated for transmission of the first uplink HARQ feedback information.

In some aspects, the communication manager 150 may receive, via an uplink control channel, first uplink HARQ feedback information comprising first sidelink HARQ feedback information associated with at least one sidelink transmission, the first uplink HARQ feedback information comprising a HARQ-ACK codebook including at least one applicability indication associated with at least one HARQ-ACK of the first sidelink HARQ feedback information, the at least one applicability indication indicating whether the at least one HARQ-ACK is associated with an inapplicable sidelink offset value that is not applicable for indicating a timing for transmitting sidelink HARQ feedback information or an applicable sidelink offset value that is applicable for indicating a timing for transmitting sidelink HARQ feedback information; and transmit a resource allocation comprising an allocation of retransmission resources based on the at least one applicability indication. Additionally, or alternatively, the communication manager 150 may perform one or more other operations described herein.

As indicated above, FIG. 1 is provided as an example. Other examples may differ from what is described with regard to FIG. 1.

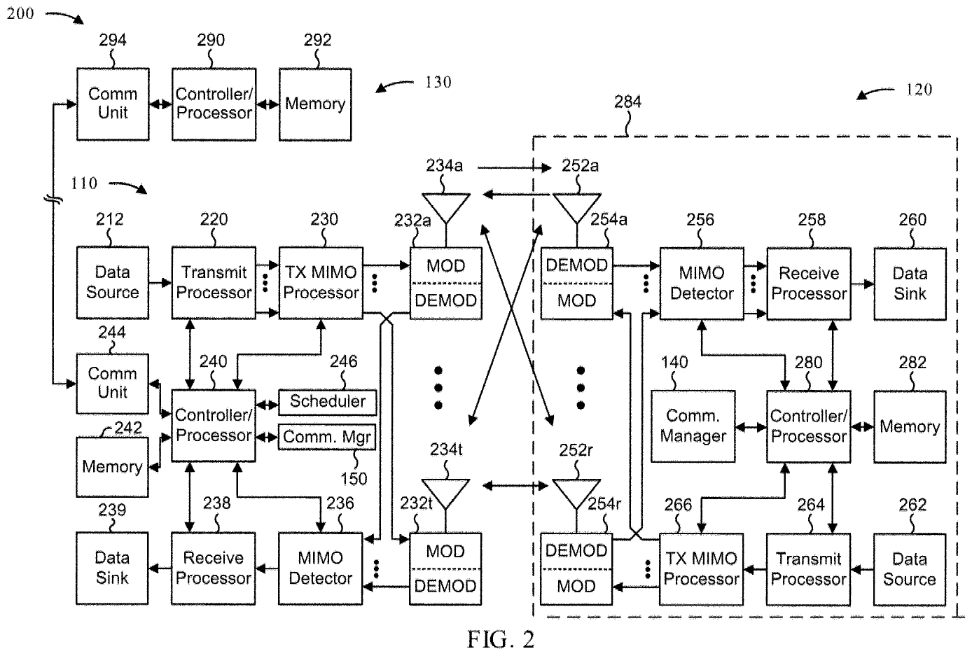

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

Each of the antenna elements may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, or other types of antennas arranged in a linear pattern, a two-dimensional pattern, or another pattern. A spacing between antenna elements may be such that signals with a desired wavelength transmitted separately by the antenna elements may interact or interfere (e.g., to form a desired beam). For example, given an expected range of wavelengths or frequencies, the spacing may provide a quarter wavelength, half wavelength, or other fraction of a wavelength of spacing between neighboring antenna elements to allow for interaction or interference of signals transmitted by the separate antenna elements within that expected range.

Antenna elements and/or sub-elements may be used to generate beams. “Beam” may refer to a directional transmission such as a wireless signal that is transmitted in a direction of a receiving device. A beam may include a directional signal, a direction associated with a signal, a set of directional resources associated with a signal (e.g., angle of arrival, horizontal direction, vertical direction), and/or a set of parameters that indicate one or more aspects of a directional signal, a direction associated with a signal, and/or a set of directional resources associated with a signal.

As indicated above, antenna elements and/or sub-elements may be used to generate beams. For example, antenna elements may be individually selected or deselected for transmission of a signal (or signals) by controlling an amplitude of one or more corresponding amplifiers. Beamforming includes generation of a beam using multiple signals on different antenna elements, where one or more, or all, of the multiple signals are shifted in phase relative to each other. The formed beam may carry physical or higher layer reference signals or information. As each signal of the multiple signals is radiated from a respective antenna element, the radiated signals interact, interfere (constructive and destructive interference), and amplify each other to form a resulting beam. The shape (such as the amplitude, width, and/or presence of side lobes) and the direction (such as an angle of the beam relative to a surface of an antenna array) can be dynamically controlled by modifying the phase shifts or phase offsets of the multiple signals relative to each other.

Beamforming may be used for communications between a UE and a network node, such as for millimeter wave communications and/or the like. In such a case, the network node may provide the UE with a configuration of transmission configuration indicator (TCI) states that respectively indicate beams that may be used by the UE, such as for receiving a physical downlink shared channel (PDSCH). A TCI state indicates a spatial parameter for a communication. For example, a TCI state for a communication may identify a source signal (such as a synchronization signal block, a channel state information reference signal, or the like) and a spatial parameter to be derived from the source signal for the purpose of transmitting or receiving the communication. For example, the TCI state may indicate a quasi-co-location (QCL) type. A QCL type may indicate one or more spatial parameters to be derived from the source signal. The source signal may be referred to as a QCL source. The network node may indicate an activated TCI state to the UE, which the UE may use to select a beam for receiving the PDSCH.

A beam indication may be, or include, a TCI state information element, a beam identifier (ID), spatial relation information, a TCI state ID, a closed loop index, a panel ID, a TRP ID, and/or a sounding reference signal (SRS) set ID, among other examples. A TCI state information element (referred to as a TCI state herein) may indicate information associated with a beam such as a downlink beam. For example, the TCI state information element may indicate a TCI state identification (e.g., a tci-StateID), a QCL type (e.g., a qcl-Type1, qcl-Type2, qcl-TypeA, qcl-TypeB, qcl-TypeC, qcl-TypeD, and/or the like), a cell identification (e.g., a ServCellIndex), a bandwidth part identification (bwp-Id), a reference signal identification such as a CSI-RS (e.g., an NZP-CSI-RS-ResourceId, an SSB-Index, and/or the like), and/or the like. Spatial relation information may similarly indicate information associated with an uplink beam.

The beam indication may be a joint or separate downlink (DL)/uplink (UL) beam indication in a unified TCI framework. In some cases, the network may support layer 1 (L1)-based beam indication using at least UE-specific (unicast) downlink control information (DCI) to indicate joint or separate DL/UL beam indications from active TCI states. In some cases, existing DCI formats 1_1 and/or 1_2 may be reused for beam indication. The network may include a support mechanism for a UE to acknowledge successful decoding of a beam indication. For example, the acknowledgment/negative acknowledgment (ACK/NACK) of the PDSCH scheduled by the DCI carrying the beam indication may be also used as an ACK for the DCI.

Beam indications may be provided for carrier aggregation (CA) scenarios. In a unified TCI framework, information the network may support common TCI state ID update and activation to provide common QCL and/or common UL transmission spatial filter or filters across a set of configured component carriers (CCs). This type of beam indication may apply to intra-band CA, as well as to joint DL/UL and separate DL/UL beam indications. The common TCI state ID may imply that one reference signal (RS) determined according to the TCI state(s) indicated by a common TCI state ID is used to provide QCL Type-D indication and to determine UL transmission spatial filters across the set of configured CCs.

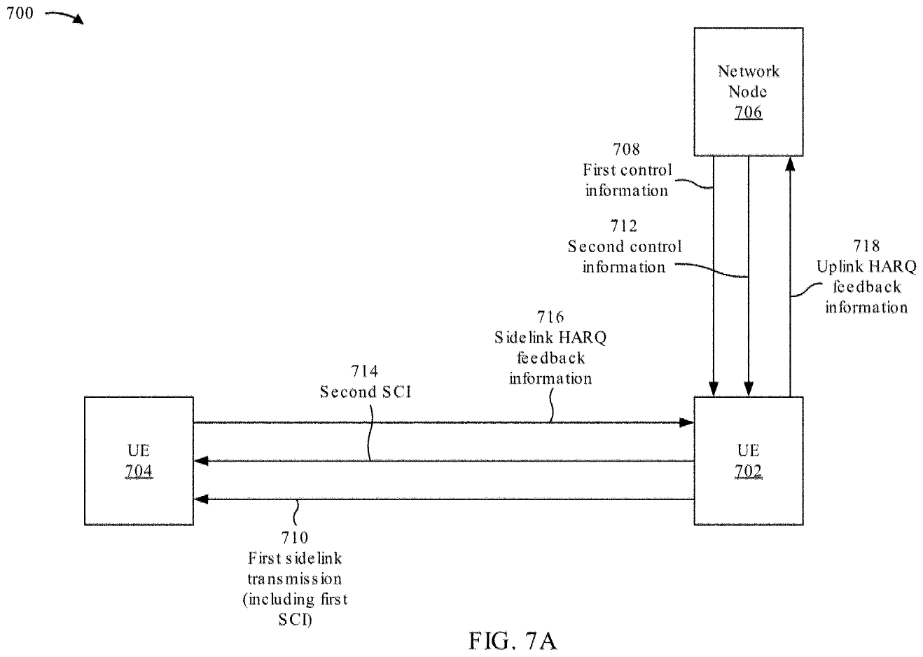

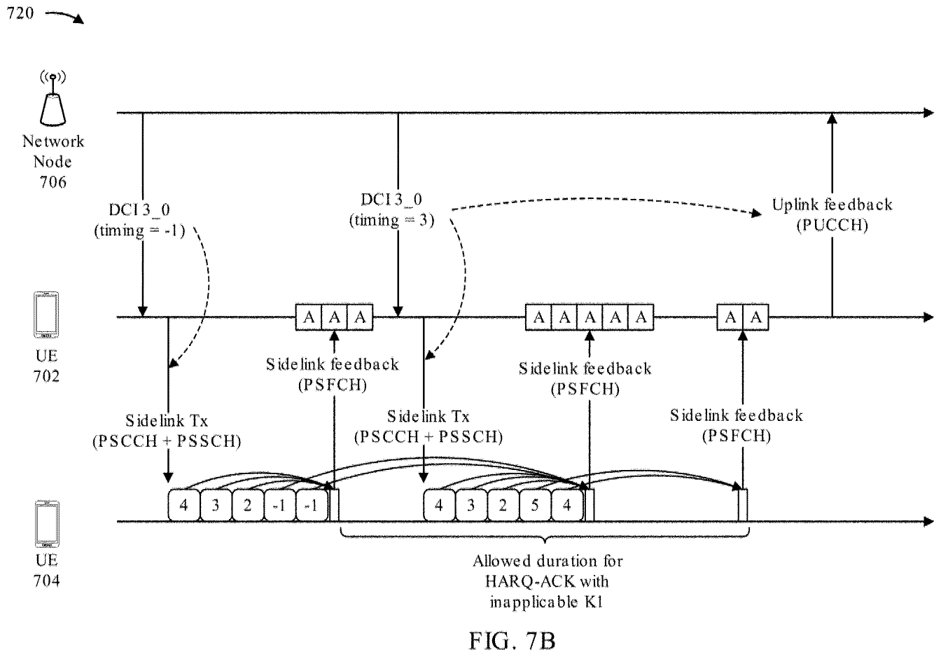

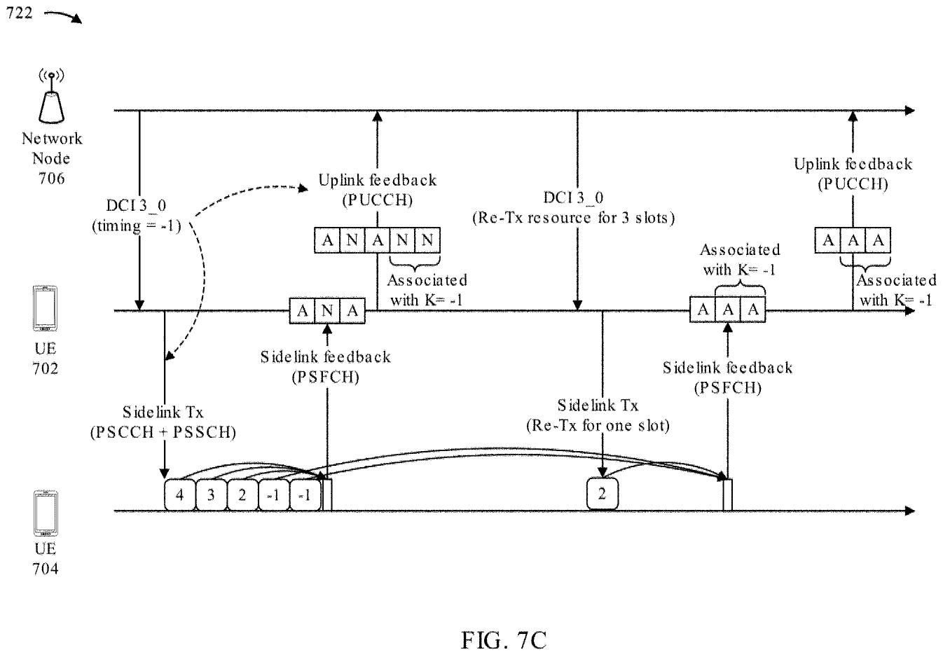

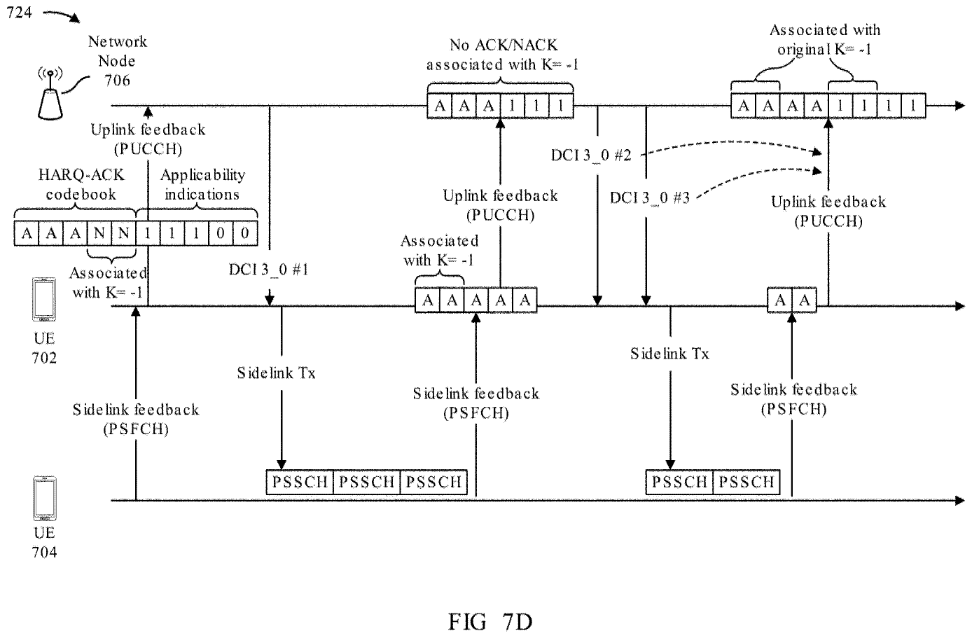

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 7A-19).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 7A-19).

In some aspects, the controller/processor 280 may be a component of a processing system. A processing system may generally be a system or a series of machines or components that receives inputs and processes the inputs to produce a set of outputs (which may be passed to other systems or components of, for example, the UE 120). For example, a processing system of the UE 120 may be a system that includes the various other components or subcomponents of the UE 120.

The processing system of the UE 120 may interface with one or more other components of the UE 120, may process information received from one or more other components (such as inputs or signals), or may output information to one or more other components. For example, a chip or modem of the UE 120 may include a processing system, a first interface to receive or obtain information, and a second interface to output, transmit, or provide information. In some examples, the first interface may be an interface between the processing system of the chip or modem and a receiver, such that the UE 120 may receive information or signal inputs, and the information may be passed to the processing system. In some examples, the second interface may be an interface between the processing system of the chip or modem and a transmitter, such that the UE 120 may transmit information output from the chip or modem. A person having ordinary skill in the art will readily recognize that the second interface also may obtain or receive information or signal inputs, and the first interface also may output, transmit, or provide information.

In some aspects, the controller/processor 240 may be a component of a processing system. A processing system may generally be a system or a series of machines or components that receives inputs and processes the inputs to produce a set of outputs (which may be passed to other systems or components of, for example, the network node 110). For example, a processing system of the network node 110 may be a system that includes the various other components or subcomponents of the network node 110.

The processing system of the network node 110 may interface with one or more other components of the network node 110, may process information received from one or more other components (such as inputs or signals), or may output information to one or more other components. For example, a chip or modem of the network node 110 may include a processing system, a first interface to receive or obtain information, and a second interface to output, transmit, or provide information. In some examples, the first interface may be an interface between the processing system of the chip or modem and a receiver, such that the network node 110 may receive information or signal inputs, and the information may be passed to the processing system. In some examples, the second interface may be an interface between the processing system of the chip or modem and a transmitter, such that the network node 110 may transmit information output from the chip or modem. A person having ordinary skill in the art will readily recognize that the second interface also may obtain or receive information or signal inputs, and the first interface also may output, transmit, or provide information.

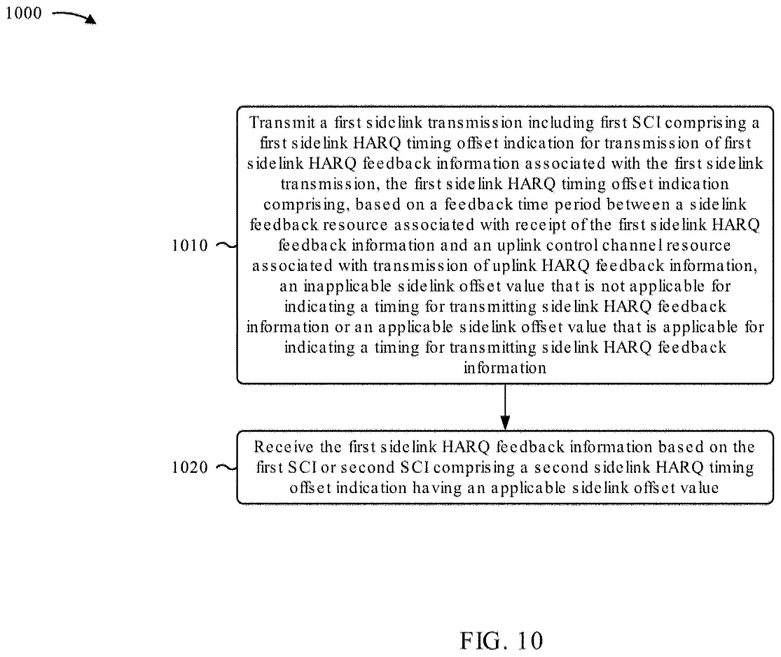

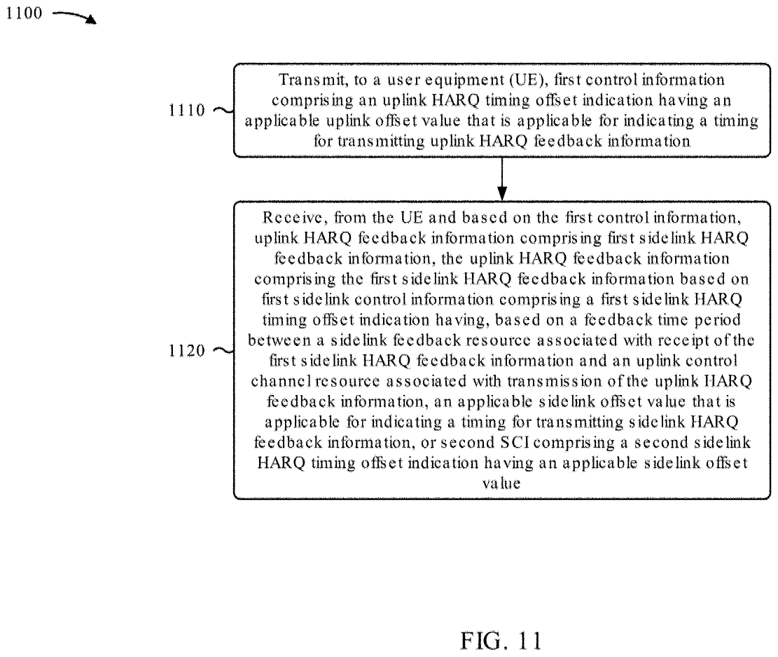

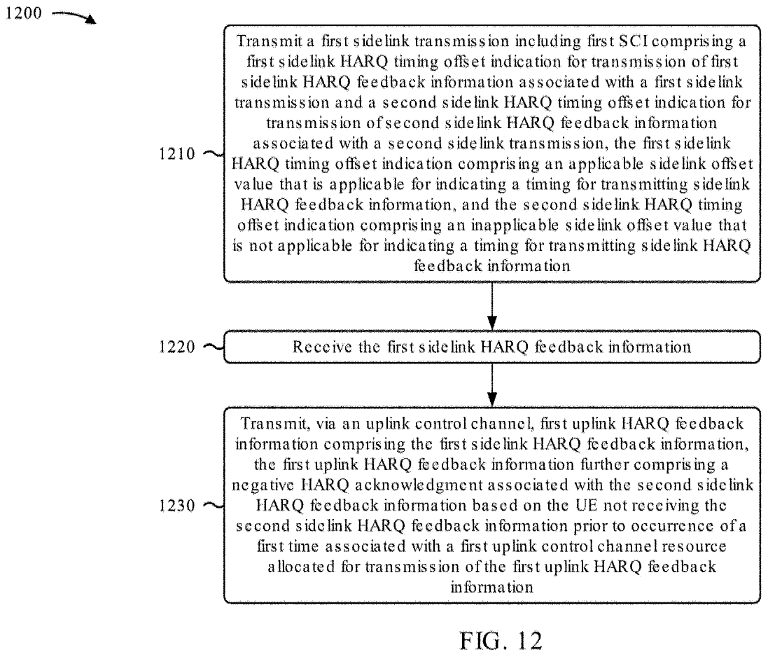

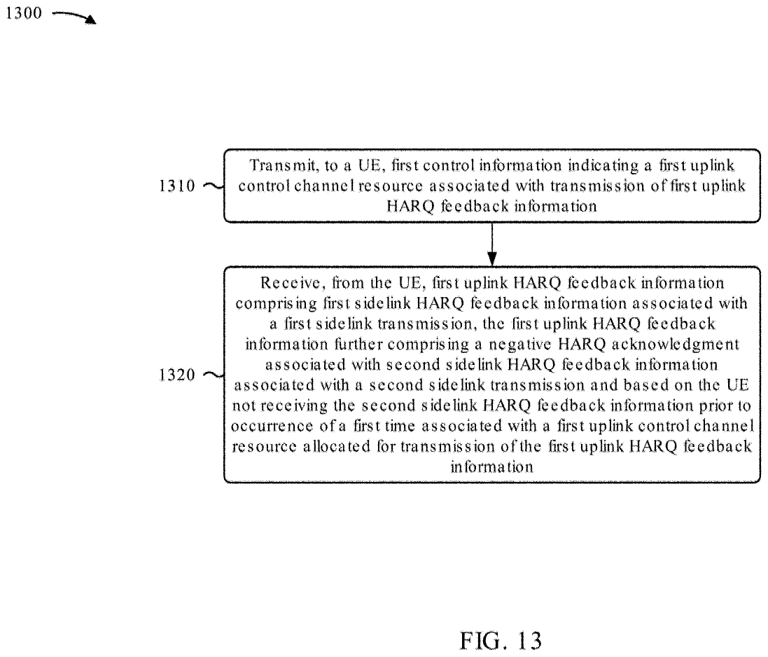

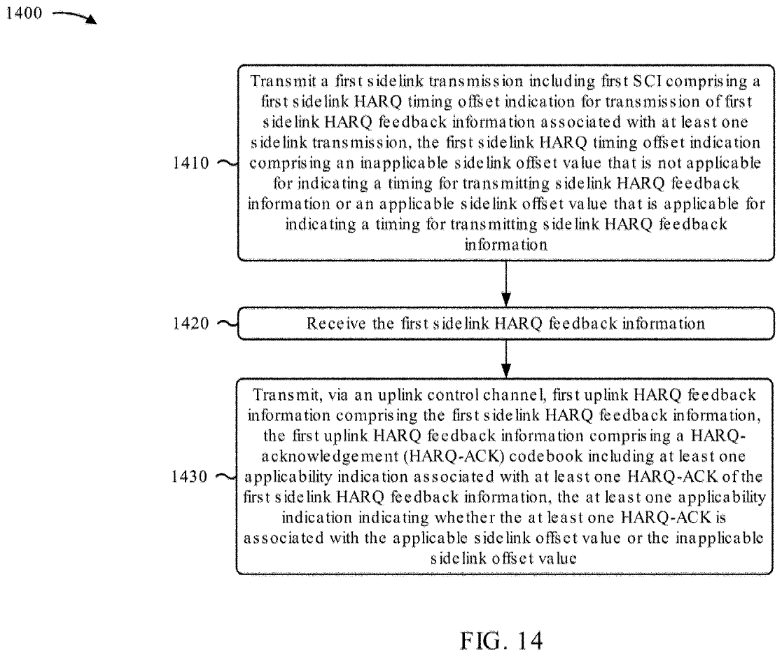

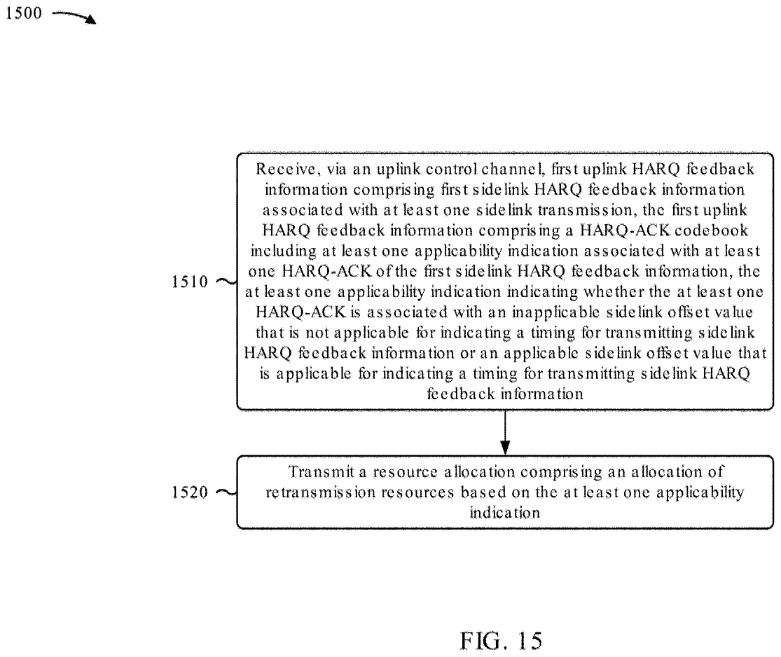

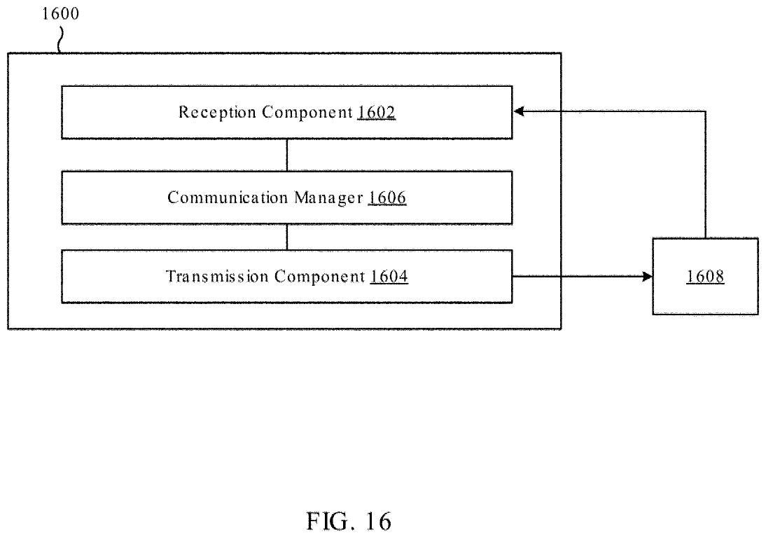

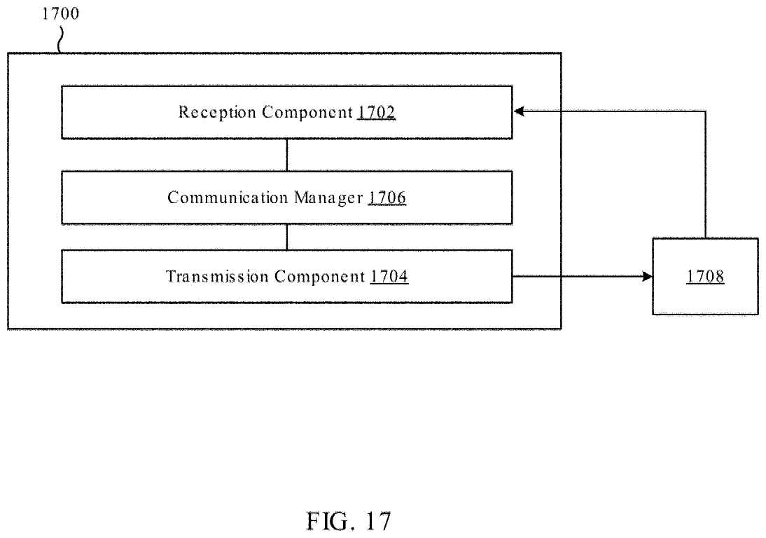

The controller/processor 240 of the network node 110, the controller/processor 280 of the UE 120, and/or any other component(s) of FIG. 2 may perform one or more techniques associated with reporting sidelink HARQ feedback information, as described in more detail elsewhere herein. For example, the controller/processor 240 of the network node 110, the controller/processor 280 of the UE 120, and/or any other component(s) of FIG. 2 may perform or direct operations of, for example, process 1000 of FIG. 10, process 1100 of FIG. 11, process 1200 of FIG. 12, process 1300 of FIG. 13, process 1400 of FIG. 14, process 1500 of FIG. 15, process 1600 of FIG. 16, process 1700 of FIG. 17, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 1000 of FIG. 10, process 1100 of FIG. 11, process 1200 of FIG. 12, process 1300 of FIG. 13, process 1400 of FIG. 14, process 1500 of FIG. 15, process 1600 of FIG. 16, process 1700 of FIG. 17, and/or other processes as described herein. In some examples, executing instructions may include running the instructions, converting the instructions, compiling the instructions, and/or interpreting the instructions, among other examples.

In some aspects, a UE (e.g., the UE 120) includes means for receiving first control information comprising a first sidelink HARQ timing offset configuration indication that indicates a state of an inapplicable sidelink offset value that is not applicable for indicating a timing for transmitting sidelink HARQ feedback information; and/or means for transmitting a first sidelink transmission including first SCI comprising a first sidelink HARQ timing offset indication for transmission of first sidelink HARQ feedback information associated with the first sidelink transmission, the first sidelink HARQ timing offset indication comprising, based on the first sidelink HARQ timing offset configuration indication, the inapplicable sidelink offset value or an applicable sidelink offset value that is applicable for indicating a timing for transmitting sidelink HARQ feedback information.

In some aspects, a UE (e.g., the UE 120) includes means for transmitting a first sidelink transmission including first SCI comprising a first sidelink HARQ timing offset indication for transmission of first sidelink HARQ feedback information associated with the first sidelink transmission, the first sidelink HARQ timing offset indication comprising, based on a feedback time period between a sidelink feedback resource associated with receipt of the first sidelink HARQ feedback information and an uplink control channel resource associated with transmission of uplink HARQ feedback information, an inapplicable sidelink offset value that is not applicable for indicating a timing for transmitting sidelink HARQ feedback information or an applicable sidelink offset value that is applicable for indicating a timing for transmitting sidelink HARQ feedback information; and/or means for receiving the first sidelink HARQ feedback information based on the first SCI or second SCI comprising a second sidelink HARQ timing offset indication having an applicable sidelink offset value.

In some aspects, a UE (e.g., the UE 120) includes means for transmitting a first sidelink transmission including first SCI comprising a first sidelink HARQ timing offset indication for transmission of first sidelink HARQ feedback information associated with a first sidelink transmission and a second sidelink HARQ timing offset indication for transmission of second sidelink HARQ feedback information associated with a second sidelink transmission, the first sidelink HARQ timing offset indication comprising an applicable sidelink offset value that is applicable for indicating a timing for transmitting sidelink HARQ feedback information, and the second sidelink HARQ timing offset indication comprising an inapplicable sidelink offset value that is not applicable for indicating a timing for transmitting sidelink HARQ feedback information; means for receiving the first sidelink HARQ feedback information; and/or means for transmitting, via an uplink control channel, first uplink HARQ feedback information comprising the first sidelink HARQ feedback information, the first uplink HARQ feedback information further comprising a negative HARQ acknowledgment associated with the second sidelink HARQ feedback information based on the UE not receiving the second sidelink HARQ feedback information prior to occurrence of a first time associated with a first uplink control channel resource allocated for transmission of the first uplink HARQ feedback information.

In some aspects, a UE (e.g., the UE 120) includes means for transmitting a first sidelink transmission including first SCI comprising a first sidelink HARQ timing offset indication for transmission of first sidelink HARQ feedback information associated with at least one sidelink transmission, the first sidelink HARQ timing offset indication comprising an inapplicable sidelink offset value that is not applicable for indicating a timing for transmitting sidelink HARQ feedback information or an applicable sidelink offset value that is applicable for indicating a timing for transmitting sidelink HARQ feedback information; means for receiving the first sidelink HARQ feedback information; and/or means for transmitting, via an uplink control channel, first uplink HARQ feedback information comprising the first sidelink HARQ feedback information, the first uplink HARQ feedback information comprising a HARQ-ACK codebook including at least one applicability indication associated with at least one HARQ-ACK of the first sidelink HARQ feedback information, the at least one applicability indication indicating whether the at least one HARQ-ACK is associated with the applicable sidelink offset value or the inapplicable sidelink offset value. The means for the UEs described herein to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network node (e.g., the network node 110) includes means for transmitting first control information comprising a first sidelink HARQ timing offset configuration indication that indicates an enabled state of an inapplicable sidelink offset value that is not applicable for indicating a timing for transmitting sidelink HARQ feedback information; means for transmitting second control information comprising a second sidelink HARQ timing offset configuration indication that indicates a disabled state of the inapplicable sidelink offset value; and/or means for receiving, via an uplink control channel and based on the second control information, uplink HARQ feedback information comprising first sidelink HARQ feedback information associated with a first sidelink transmission and second sidelink HARQ feedback information associated with a second sidelink transmission, the uplink HARQ feedback information comprising the first sidelink HARQ feedback information based on the first control information.

In some aspects, a network node (e.g., the network node 110) includes means for transmitting, to a UE, first control information comprising an uplink HARQ timing offset indication having an applicable uplink offset value that is applicable for indicating a timing for transmitting uplink HARQ feedback information; and/or means for receiving, from the UE and based on the first control information, uplink HARQ feedback information comprising first sidelink HARQ feedback information, the uplink HARQ feedback information comprising the first sidelink HARQ feedback information based on: first sidelink control information comprising a first sidelink HARQ timing offset indication having, based on a feedback time period between a sidelink feedback resource associated with receipt of the first sidelink HARQ feedback information and an uplink control channel resource associated with transmission of the uplink HARQ feedback information, an applicable sidelink offset value that is applicable for indicating a timing for transmitting sidelink HARQ feedback information, or second SCI comprising a second sidelink HARQ timing offset indication having an applicable sidelink offset value.

In some aspects, a network node (e.g., the network node 110) includes means for transmitting, to a UE, first control information indicating a first uplink control channel resource associated with transmission of first uplink HARQ feedback information; and/or means for receiving, from the UE, first uplink HARQ feedback information comprising first sidelink HARQ feedback information associated with a first sidelink transmission, the first uplink HARQ feedback information further comprising a negative HARQ acknowledgment associated with second sidelink HARQ feedback information associated with a second sidelink transmission and based on the UE not receiving the second sidelink HARQ feedback information prior to occurrence of a first time associated with a first uplink control channel resource allocated for transmission of the first uplink HARQ feedback information.

In some aspects, a network node (e.g., the network node 110) includes means for receiving, via an uplink control channel, first uplink HARQ feedback information comprising first sidelink HARQ feedback information associated with at least one sidelink transmission, the first uplink HARQ feedback information comprising a HARQ-ACK codebook including at least one applicability indication associated with at least one HARQ-ACK of the first sidelink HARQ feedback information, the at least one applicability indication indicating whether the at least one HARQ-ACK is associated with an inapplicable sidelink offset value that is not applicable for indicating a timing for transmitting sidelink HARQ feedback information or an applicable sidelink offset value that is applicable for indicating a timing for transmitting sidelink HARQ feedback information; and/or means for transmitting a resource allocation comprising an allocation of retransmission resources based on the at least one applicability indication. The means for the network nodes described herein to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

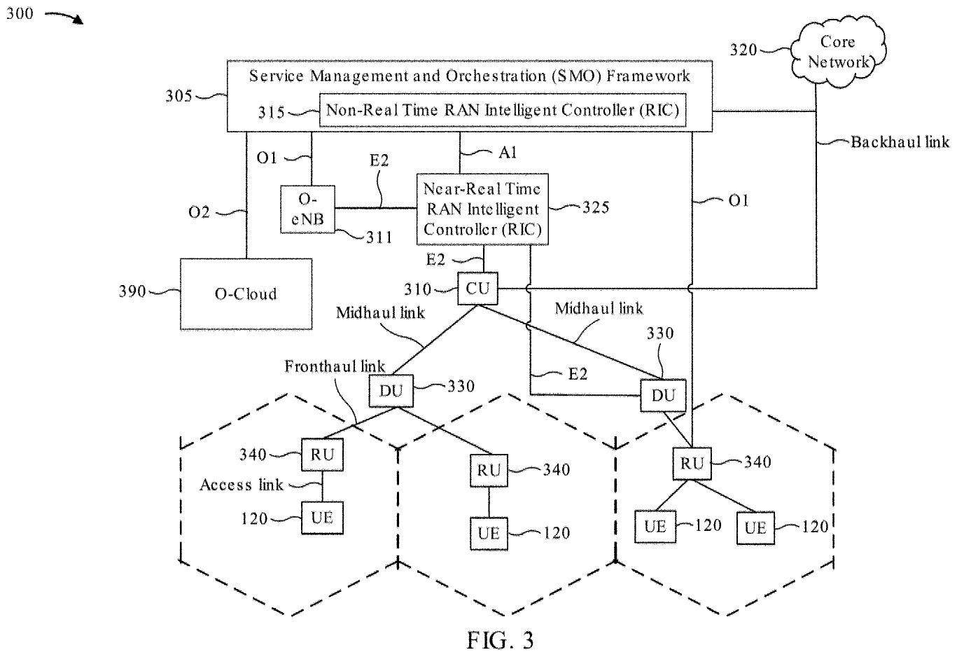

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

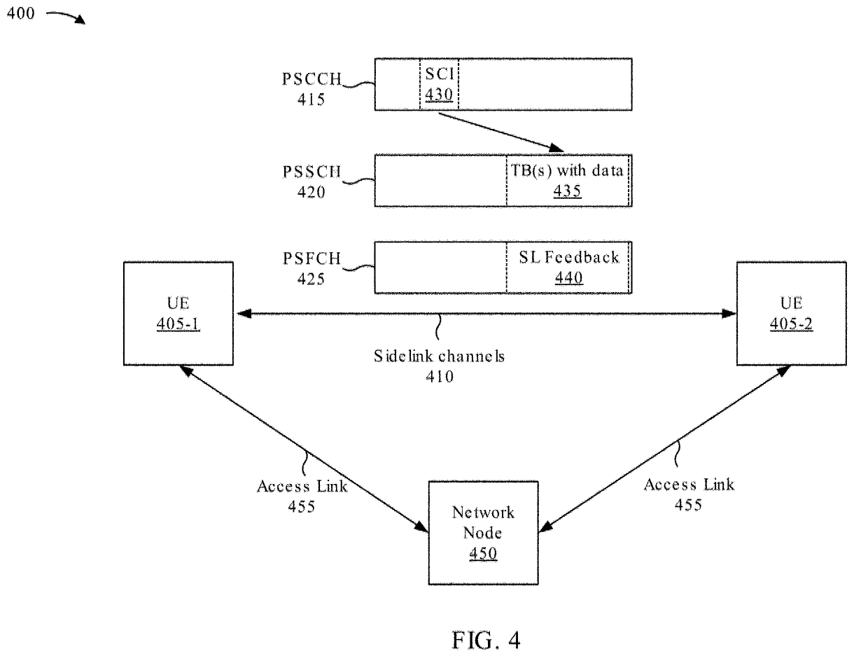

FIG. 4 is a diagram illustrating an example 400 of sidelink communications, in accordance with the present disclosure.

As shown in FIG. 4, a first UE 405-1 may communicate with a second UE 405-2 (and one or more other UEs 405) via one or more sidelink channels 410. The UEs 405-1 and 405-2 may communicate using the one or more sidelink channels 410 for P2P communications, D2D communications, V2X communications (e.g., which may include V2V communications, V2I communications, and/or V2P communications) and/or mesh networking. In some aspects, the UEs 405 (e.g., UE 405-1 and/or UE 405-2) may correspond to one or more other UEs described elsewhere herein, such as UE 120. In some aspects, the one or more sidelink channels 410 may use a PC5 interface and/or may operate in a high frequency band (e.g., the 5.9 GHz band). Additionally, or alternatively, the UEs 405 may synchronize timing of transmission time intervals (TTIs) (e.g., frames, subframes, slots, or symbols) using global navigation satellite system (GNSS) timing.

As further shown in FIG. 4, the one or more sidelink channels 410 may include a physical sidelink control channel (PSCCH) 415, a PSSCH 420, and/or a PSFCH 425. The PSCCH 415 may be used to communicate control information, similar to a physical downlink control channel (PDCCH) and/or a PUCCH used for cellular communications with a network node 110 via an access link or an access channel. The PSSCH 420 may be used to communicate data, similar to a physical downlink shared channel (PDSCH) and/or a physical uplink shared channel (PUSCH) used for cellular communications with a network node 110 via an access link or an access channel. For example, the PSCCH 415 may carry SCI 430, which may indicate various control information used for sidelink communications, such as one or more resources (e.g., time resources, frequency resources, and/or spatial resources) where a transport block (TB) 435 may be carried on the PSSCH 420. The TB 435 may include data. The PSFCH 425 may be used to communicate sidelink feedback 440, such as HARQ feedback (e.g., acknowledgment or negative acknowledgment (ACK/NACK) information), transmit power control (TPC), and/or a scheduling request (SR).

HARQ feedback provides a mechanism for indicating, to a transmitter of a communication, whether the communication was successfully received or not. For example, the transmitter may transmit scheduling information for the communication. A receiver of the scheduling information may monitor resources indicated by the scheduling information in order to receive the communication. If the receiver successfully receives the communication, the receiver may transmit an acknowledgment (ACK) in HARQ feedback. If the receiver fails to receive the communication, the receiver may transmit a negative ACK (NACK) in HARQ feedback. Thus, based at least in part on the HARQ feedback, the transmitter can determine whether the communication should be retransmitted. HARQ feedback is often implemented using a single bit, where a first value of the bit indicates an ACK and a second value of the bit indicates a NACK. Such a bit may be referred to as a HARQ-ACK bit. HARQ-ACK feedback may be conveyed in a HARQ codebook, which may include one or more bits indicating ACKs or NACKs corresponding to one or more communications and may be referred to as HARQ feedback information (or, in the case of sidelink communications, “sidelink HARQ feedback information”).

A HARQ-ACK bit may be referred to as an ACK/NACK and/or a HARQ-ACK and may be associated with a HARQ process. “HARQ process” refers to the determination of whether to report an ACK or NACK associated with a transmission, a time resource associated with the transmission (e.g., a symbol or a slot), and/or a frequency resource associated with the transmission (e.g., a resource block (RB), a subchannel, a channel, a bandwidth, and/or a bandwidth part). Accordingly, an ACK/NACK may be interchangeably referred to as being associated with a transmission, a time resource, a frequency resource, and/or a HARQ process.

Although shown on the PSCCH 415, in some aspects, the SCI 430 may include multiple communications in different stages, such as a first stage SCI (SCI-1) and a second stage SCI (SCI-2). The SCI-1 may be transmitted on the PSCCH 415. The SCI-2 may be transmitted on the PSSCH 420. The SCI-1 may include, for example, an indication of one or more resources (e.g., time resources, frequency resources, and/or spatial resources) on the PSSCH 420, information for decoding sidelink communications on the PSSCH, a quality of service (QoS) priority value, a resource reservation period, a PSSCH DMRS pattern, an SCI format for the SCI-2, a beta offset for the SCI-2, a quantity of PSSCH DMRS ports, and/or an MCS. The SCI-2 may include information associated with data transmissions on the PSSCH 420, such as a HARQ process ID, a new data indicator (NDI), a source identifier, a destination identifier, and/or a channel state information (CSI) report trigger.

In some aspects, the one or more sidelink channels 410 may use resource pools. Resource pools may be defined for sidelink transmission and sidelink reception. A resource pool may include one or more sub-channels in the frequency domain and one or more slots in the time domain. For example, the minimum resource allocation in the frequency domain may be a sub-channel, and the minimum resource allocation in the time domain may be a slot. In some aspects, one or more slots of a resource pool may be unavailable for sidelink communications. For example, a scheduling assignment (e.g., included in SCI 430) may be transmitted in sub-channels using specific resource blocks (RBs) across time. In some aspects, data transmissions (e.g., on the PSSCH 420) associated with a scheduling assignment may occupy adjacent RBs in the same subframe as the scheduling assignment (e.g., using frequency division multiplexing). In some aspects, a scheduling assignment and associated data transmissions are not transmitted on adjacent RBs.

In some aspects, a UE 405 may operate using a sidelink transmission mode (e.g., Mode 1), where resource selection and/or scheduling is performed by a network node 110 (e.g., a base station, a CU, or a DU). For example, the UE 405 may receive a grant (e.g., in DCI or in a radio resource control (RRC) message, such as for configured grants) from the network node 110 (e.g., directly or via one or more network nodes) for sidelink channel access and/or scheduling. In some aspects, a UE 405 may operate using a transmission mode (e.g., Mode 2) where resource selection and/or scheduling is performed by the UE 405 (e.g., rather than a network node 110). In some aspects, the UE 405 may perform resource selection and/or scheduling by sensing channel availability for transmissions. For example, the UE 405 may measure an RSSI parameter (e.g., a sidelink-RSSI (S-RSSI) parameter) associated with various sidelink channels, may measure an RSRP parameter (e.g., a PSSCH-RSRP parameter) associated with various sidelink channels, and/or may measure an RSRQ parameter (e.g., a PSSCH-RSRQ parameter) associated with various sidelink channels, and may select a channel for transmission of a sidelink communication based at least in part on the measurement(s).

Additionally, or alternatively, the UE 405 may perform resource selection and/or scheduling using SCI 430 received in the PSCCH 415, which may indicate occupied resources and/or channel parameters. Additionally, or alternatively, the UE 405 may perform resource selection and/or scheduling by determining a channel busy ratio (CBR) associated with various sidelink channels, which may be used for rate control (e.g., by indicating a maximum number of resource blocks that the UE 405 can use for a particular set of subframes).

In the transmission mode where resource selection and/or scheduling is performed by a UE 405, the UE 405 may generate sidelink grants, and may transmit the grants in SCI 430. A sidelink grant may indicate, for example, one or more parameters (e.g., transmission parameters) to be used for an upcoming sidelink transmission, such as one or more resource blocks to be used for the upcoming sidelink transmission on the PSSCH 420 (e.g., for TBs 435), one or more subframes to be used for the upcoming sidelink transmission, and/or an MCS to be used for the upcoming sidelink transmission. In some aspects, a UE 405 may generate a sidelink grant that indicates one or more parameters for semi-persistent scheduling (SPS), such as a periodicity of a sidelink transmission. Additionally, or alternatively, the UE 405 may generate a sidelink grant for event-driven scheduling, such as for an on-demand sidelink message.

As shown, a network node 450 may communicate with the UE 405-1 and/or the UE 405-2 (e.g., directly or via one or more network nodes), such as via an access link 455. A direct link between the UEs 450-1 and 450-2 (e.g., via a PC5 interface) may be referred to as a sidelink, and a direct link between a network node 450 and a UE 450-1 or 450-2 (e.g., via a Uu interface) may be referred to as an access link. Sidelink communications may be transmitted via the sidelink, and access link communications may be transmitted via the access link. An access link communication may be either a downlink communication (from the network node 450 to the UE 450-1 or 450-2) or an uplink communication (from a UE 450-1 or 450-2 to the network node 450).

As indicated above, FIG. 4 is provided as an example. Other examples may differ from what is described with respect to FIG. 4.

In some cases, such as in Mode 1 sidelink scenarios, a transmitting sidelink UE can provide uplink HARQ feedback information to a network node. The uplink HARQ feedback information may include sidelink HARQ feedback information received by the transmitting sidelink UE, from a receiving sidelink UE, in response to a sidelink transmission.

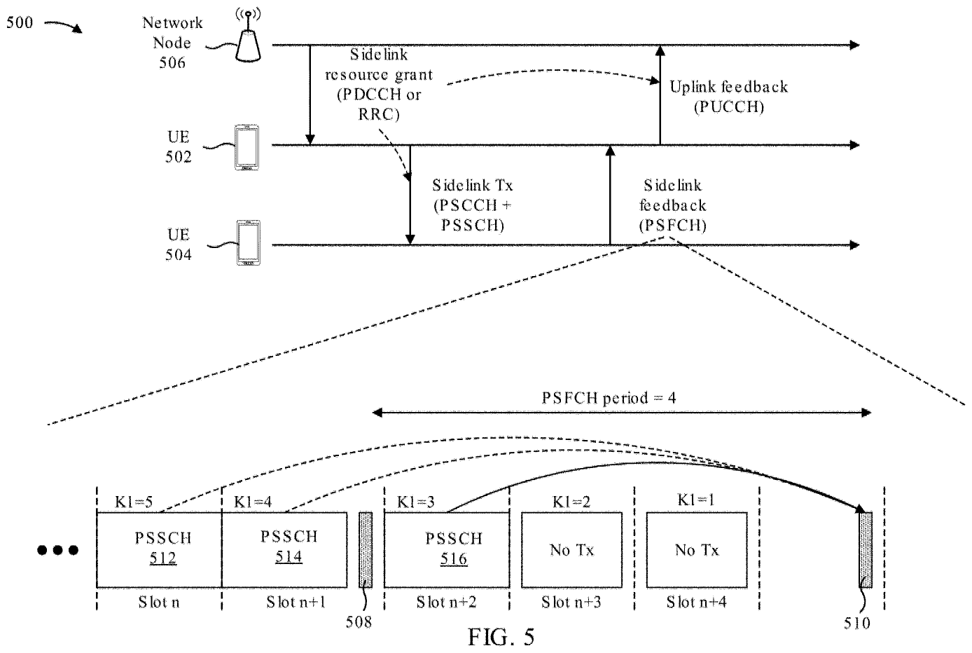

FIG. 5 is a diagram illustrating an example associated with sidelink HARQ reporting and uplink HARQ reporting, in accordance with the present disclosure. As shown, a UE 502 may communicate, via a sidelink, with a UE 504. The UE 502 also may communicate with a network node 506. The UE 502 and/or the UE 504 may be, be similar to, include, or be included in, the UE 405-1 and/or the UE 405-2 depicted in FIG. 4, and/or the UE 120 depicted in FIGS. 1-3. The network node 506 may be, be similar to, include, or be included in, the network node 450 depicted in FIG. 4, the network node 110 depicted in FIGS. 1 and 2, and/or one or more components of the disaggregated base station architecture 300 depicted in FIG. 3.

As shown, the network node 506 may transmit a sidelink resource grant to the UE 502. The sidelink resource grant may allocate one or more sidelink resources to be used by the UE 502 and the UE 504. The sidelink resource grant may be transferred via a physical downlink control channel (PDCCH) communication (e.g., DCI) and/or a radio resource control (RRC) communication. The sidelink resource grant also may indicate a timing for transmitting uplink HARQ feedback information. The timing may include, for example, a feedback time period between a sidelink feedback resource associated with receipt of sidelink HARQ feedback information and an uplink control channel resource associated with transmission of uplink HARQ feedback information.

As shown, the UE 502 may transmit a sidelink transmission (“sidelink Tx”) to the UE 504. The sidelink transmission may include a PSCCH communication and a PSSCH communication. In some cases, the sidelink transmission (e.g., the PSCCH communication) may configure a PSFCH for the UE 504 to use to report sidelink HARQ feedback information associated with the sidelink transmission. A sidelink resource pool can be configured with a PSFCH periodicity, which indicates a periodicity of PSFCH transmissions associated with the resource pool. In example 500, the resource pool is configured with a PSFCH periodicity of 4

$$( {N}_{PSSCH}^{PSFCH} = 4 ) .$$

### PSFCH

resources 508, 510 indicated by the PSFCH periodicity are in every fourth slot of the resource pool.

The UE 502 may allocate a configured number of physical resource blocks (PRBs) for the PSFCH resources 508, 510. A PRB is a group of subcarriers, and may include, for example, 12 subcarriers. As mentioned above, the PSFCH resources 508, 510 may be used to transmit HARQ feedback information regarding PSSCHs received in the resource pool. Sidelink HARQ feedback information may be sequence-based, and may carry a single bit per PSSCH. Sidelink HARQ feedback information may be sent on two consecutive symbols (e.g., symbols 11 and 12 of a slot). In some cases, one symbol before and one symbol after a PSFCH occasion may be assigned to a gap. A periodicity parameter (e.g., periodPSFCHresource) may indicate the PSFCH periodicity, in terms of a number of slots, for a resource pool. For example, the PSFCH periodicity can be set to a value in the set {0,1,2,4}. If the PSFCH periodicity is set to 0, PSFCH transmissions from a UE in the resource pool are disabled. In example 500, the PSFCH periodicity is set to 4, so PSFCH transmissions are performed in every fourth slot.

The UE 504 may transmit the PSFCH in a slot indicated by a dynamic HARQ offset value (K1). As shown in Example 500, the UE 504 may transmit sidelink HARQ feedback information associated with a PSSCH 512 using the PSFCH resources 510 based on a value of K1 being equal to 5, sidelink HARQ feedback information associated with a PSSCH 514 using the PSFCH resources 510 based on a value of K1 being equal to 4, and sidelink HARQ feedback information associated with a PSSCH 516 using the PSFCH resources 510 based on a value of K1 being equal to 3. However, due to the existence of UE processing delay, for the last few PSSCH transmissions within a current channel occupancy time (COT), the corresponding HARQ-ACK feedback will be located outside the current COT. In this case, those HARQ-ACKs may be reported in a following COT, which may be occupied by a non-sidelink device, resulting in HARQ-ACK reporting failure.

In some cases, a dynamic HARQ timeline may be used by indicating, in first SCI, an inapplicable HARQ offset value K1 to indicate that the corresponding HARQ feedback information is to be held until a later time. An inapplicable offset value may be a value that is not applicable for indicating a timing for transmitting sidelink HARQ feedback information. For example, the inapplicable value (e.g., “−1”) may be added to the K1 value set. The dynamic feedback timing may be determined based on an applicable K1 indicated in second SCI. An applicable offset value is a value that is applicable for indicating a timing for transmitting sidelink HARQ feedback information. For example, an applicable offset value K1 may be a positive integer. In this way, the HARQ feedback information may be sent during a COT occupied by the UE 502 for which the HARQ feedback is intended, thereby mitigating the risk of HARQ-ACK reporting failure.

As indicated above, FIG. 5 is provided as an example. Other examples may differ from what is described with respect to FIG. 5.

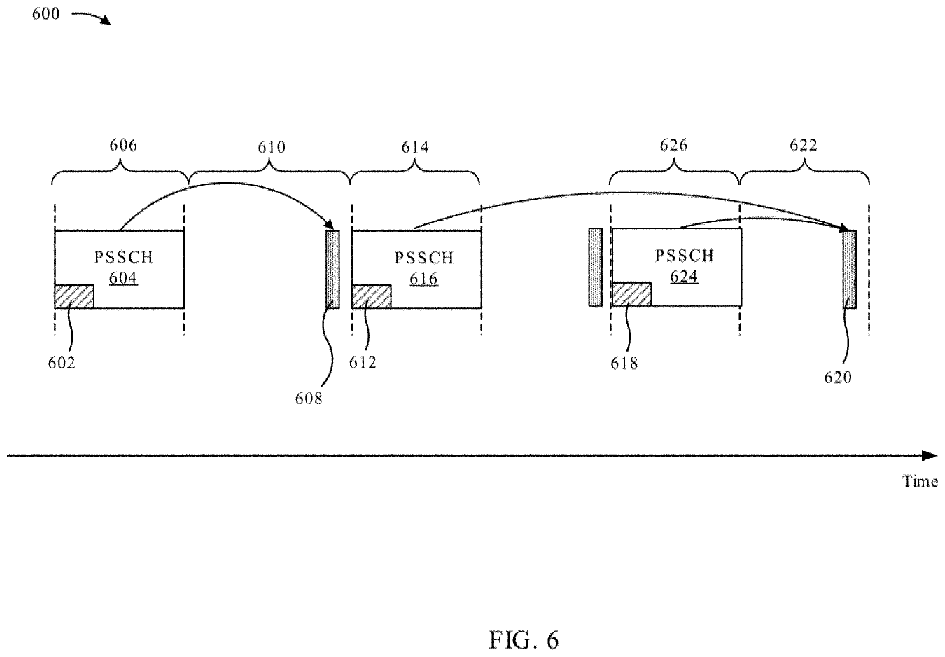

FIG. 6 is a diagram illustrating an example 600 of dynamic HARQ timing for transmitting feedback information, in accordance with the present disclosure. Example 600 depicts sidelink communications that may, for example, be performed by the UE 502 and the UE 504 depicted in FIG. 5.

As shown, a transmitter UE may transmit SCI 602 in a PSSCH 604 associated with a slot 606. In some cases, the SCI 602 may include a sidelink HARQ timing offset indication that includes an applicable offset value indicating a PSFCH 608 in a slot 610 for transmitting HARQ feedback information associated with a PSSCH communication transmitted in the PSSCH 604. The transmitter UE may transmit SCI 612 in a slot 614 that may include a dynamic sidelink HARQ timing offset indication for transmitting sidelink HARQ feedback information associated with a PSSCH communication transmitted in a PSSCH 616. The SCI 612 may include a dynamic HARQ timing offset indication including an inapplicable offset value. For example, in some aspects, if the receiving UE receives DCI that includes a PDSCH-to-HARQ feedback timing indicator field providing an inapplicable value from dl-DataToUL-ACK-r16, the behavior of HARQ feedback information is to be held until a later time.

At a later time, the transmitter UE may transmit SCI 618. The SCI 618 may include a dynamic sidelink HARQ timing offset indication that includes an applicable offset value indicating a PSFCH 620, in a slot 622, for transmitting sidelink HARQ feedback information associated with a PSSCH communication in a PSSCH 624 received in a slot 626. The receiving UE can transmit, in the PSFCH 620, the sidelink HARQ feedback information associated with the PSSCH communication in the PSSCH 616 as well as sidelink HARQ feedback information associated with the PSSCH communication received in the PSSCH 624.

As described above in connection with FIG. 5, a UE can report sidelink HARQ feedback information to a network node via uplink HARQ feedback information in a PUCCH. In some cases, the network node can allocate the PUCCH resources for reporting the HARQ feedback information. In some groupcast scenarios, the UE can report a NACK if the UE did not transmit PSSCH due to intra-UE prioritization or receiving a PSFCH communication. In some groupcast scenarios, the UE can report an ACK if the UE has received an ACK at some point from each UE in the group. In a configured grant scenario, the UE can report an ACK if the UE does not have data to transmit.

In some sidelink modes, the HARQ-ACK feedback information can be transmitted in the PUCCH configured after the PSFCH associated with the last allocated resource in a dynamic grant or in each configured grant period. Since the PSFCH transmission timing can be defined to be the first slot with a PSFCH resource after a configured (or pre-configured) number, K, of slots after the PSSCH, the network node can set a correct timing for PSFCH to PUCCH feedback to ensure that all of the HARQ-ACK feedback can be reported. However, in some sidelink scenarios, as described above in connection with FIG. 6, HARQ-ACK feedback reporting can be configured for inapplicable offset values of sidelink HARQ timing offset K1. As shown in FIG. 6, the PSFCH associated with allocated resources can be determined based on a next SCI with an applicable HARQ timing offset K1.

Dynamic HARQ feedback offsets that support inapplicable offset values can be introduced into Mode 1 sidelink. Introducing dynamic HARQ feedback offsets that support inapplicable offset values into Mode 1 sidelink can result in an inconsistent understanding between the UE and the network node with respect to uplink HARQ feedback timing. As a result, some uplink HARQ feedback information may be missed by the network node, which may negatively impact network communications due to inappropriate and/or insufficient allocation of sidelink resources.

Some aspects of the techniques and apparatuses described herein may include a timing scheme for reporting sidelink HARQ feedback information to a network node. In some aspects, the use of inapplicable offset values may be indicated by the network node and, in some other aspects, the transmitter UE may independently determine whether to use inapplicable offset values.

For example, in some aspects, a network node may provide, to a UE, control information that indicates a state (e.g., allowed or disallowed) of an inapplicable sidelink offset value associated with allocated sidelink resources. In some aspects, the control information may indicate an applicable value or an inapplicable value of an uplink HARQ offset indication associated with timing for transmitting uplink HARQ feedback information. If the applicable value is indicated, the UE may determine that inapplicable values of sidelink HARQ timing offset indications are disallowed because the applicable value indicates a PUCCH in which the UE is to transmit uplink HARQ feedback information. If the inapplicable value is indicated, the UE may determine that inapplicable values of sidelink HARQ timing offset indications are allowed since there is no indicated PUCCH for transmitting the uplink HARQ feedback information. Thus, the UE may use an inapplicable sidelink HARQ timing offset indication value to defer HARQ feedback information reception until further indicated by the network node. In this way, some aspects may facilitate network control of whether inapplicable HARQ timing offset values are used, and, thus, the network node and the UE may both have the same feedback timing information, thereby mitigating the risk of missed uplink HARQ feedback information transmissions, inappropriate sidelink resource allocations, and/or inefficient sidelink resource allocations.

In some aspects, a UE may determine whether to use inapplicable sidelink HARQ timing offset indication values. In some aspects, the UE may determine whether to use an inapplicable sidelink HARQ timing offset indication value based on a feedback time period between a sidelink feedback resource associated with receipt of the first sidelink HARQ feedback information and an uplink control channel resource associated with transmission of the uplink HARQ feedback information. For example, if the feedback time period satisfies a timing threshold, the time period may be so long that there is a likelihood of the UE receiving second sidelink HARQ feedback information prior to an occurrence of a PUCCH for transmitting uplink HARQ feedback information including first sidelink HARQ feedback information. Accordingly, the UE may use the inapplicable sidelink HARQ timing offset indication value to defer reception of the second sidelink HARQ feedback information. Otherwise, the UE may use an applicable sidelink HARQ timing offset indication value to request the first sidelink HARQ feedback information. In this way, some aspects may facilitate UE control, based on a length of a PSFCH-to-PUCCH time period, of whether inapplicable sidelink HARQ timing offset indication values are used to defer reception of HARQ feedback information, in which case the uplink feedback timing information may be independent of the sidelink feedback timing from the perspective of the network node, thereby mitigating the risk of missed uplink HARQ feedback information transmissions, inappropriate sidelink resource allocations, and/or inefficient sidelink resource allocations.

In some aspects, the UE may determine whether to use inapplicable sidelink HARQ timing offset indication values and for uplink HARQ feedback reporting, the UE may generate a NACK for a HARQ process associated with a sidelink transmission if the UE has not received sidelink HARQ feedback information associated with the sidelink transmission. Before the UE receives sidelink HARQ feedback information associated with an inapplicable sidelink HARQ timing offset indication value, the UE may refrain from performing retransmission associated with the corresponding HARQ processes. For example, the UE may perform retransmission associated with those HARQ processes only when a valid ACK/NACK is received. In this way, some aspects may facilitate UE control of whether inapplicable sidelink HARQ timing offset indication values are used, since the UE may provide a NACK in the uplink HARQ feedback information for any sidelink HARQ feedback information yet to be received. Thus, the uplink feedback timing information may be independent of the sidelink feedback timing from the perspective of the network node, thereby mitigating the risk of missed uplink HARQ feedback information transmissions, inappropriate sidelink resource allocations, and/or inefficient sidelink resource allocations.

In some aspects, the UE may determine whether to use inapplicable sidelink HARQ timing offset indication values, and for uplink HARQ feedback reporting, the UE may include indications in the HARQ-ACK codebook that indicate whether each ACK/NACK corresponds to an applicable sidelink HARQ timing offset indication value or an inapplicable sidelink HARQ timing offset indication value. In this way, the network node may ignore the ACK/NACKs corresponding to inapplicable sidelink HARQ timing offset indication values. For example, the network node may refrain from allocating retransmission resources for an ACK/NACK corresponding to an inapplicable sidelink HARQ timing offset indication value. In some aspects, the network node may allocate a new PUCCH to obtain the uplink HARQ feedback information associated with the inapplicable sidelink HARQ timing offset indication value. In this way, some aspects may facilitate UE control of whether inapplicable sidelink HARQ timing offset indication values are used, since the UE may provide an indication of whether each ACK/NACK in uplink HARQ feedback information is associated with an inapplicable sidelink HARQ timing offset indication value. Thus, the uplink feedback timing information may be independent of the sidelink feedback timing from the perspective of the network node, thereby mitigating the risk of missed uplink HARQ feedback information transmissions, inappropriate sidelink resource allocations, and/or inefficient sidelink resource allocations.

As indicated above, FIG. 6 is provided as an example. Other examples may differ from what is described with respect to FIG. 6.

FIG. 7A is a diagram illustrating an example 700 associated with reporting sidelink HARQ feedback information, in accordance with the present disclosure. As shown, a UE 702 may communicate, via a sidelink, with a UE 704. The UE 702 also may communicate with a network node 706. The UE 702 and/or the UE 704 may be, be similar to, include, or be included in, the UE 502 and/or the UE 504 depicted in FIG. 5, the UE 405-1 and/or the UE 405-2 depicted in FIG. 4, and/or the UE 120 depicted in FIGS. 1-3. The network node 706 may be, be similar to, include, or be included in, the network node 506 depicted in FIG. 5, the network node 450 depicted in FIG. 4, the network node 110 depicted in FIGS. 1 and 2, and/or one or more components of the disaggregated base station architecture 300 depicted in FIG. 3.

As shown by reference number 708, the network node 706 may transmit, and the UE 702 may receive, first control information. The first control information may include a first sidelink HARQ timing offset configuration indication that indicates a state of an inapplicable sidelink offset value. In some aspects, the first control information may include DCI (e.g., DCI 3_0).

In some aspects, the first sidelink HARQ timing offset configuration may include an uplink HARQ timing offset indication (which may be referred to, for example, as a PSFCH-to-PUCCH feedback timing indicator). In some aspects, if the uplink HARQ timing offset indication has an applicable uplink offset value (e.g., a value greater than or equal to 0), a first sidelink HARQ timing offset indication may include the applicable sidelink offset value. In some aspects, if the uplink HARQ timing offset indication has an inapplicable uplink offset value (e.g., a value less than 0), a first sidelink HARQ timing offset indication may include the inapplicable sidelink offset value.

In some aspects, the control information may include DCI. For example, the DCI may include a dedicated DCI transmission for indicating a feedback time period between a sidelink feedback resource associated with receipt of sidelink HARQ feedback information associated with the inapplicable sidelink offset value and an uplink control channel resource associated with transmission of uplink HARQ feedback information that includes the sidelink HARQ feedback information. In some aspects, for example, the DCI may not include a resource allocation. In some aspects, the DCI may include a set of frequency domain resource allocation (FDRA) fields. Each FDRA field of the set of FDRA fields may include an FDRA value equal to one.

As shown by reference number 710, the UE 702 may transmit, and the UE 704 may receive, a first sidelink transmission. In some aspects, the first sidelink transmission may include first SCI including a first sidelink HARQ timing offset indication for transmission of first sidelink HARQ feedback information associated with the first sidelink transmission. The first sidelink HARQ timing offset indication may include, based on the first sidelink HARQ timing offset configuration indication, an inapplicable sidelink offset value or an applicable sidelink offset value. In some aspects, the first SCI may include any number of additional sidelink HARQ timing offset indications for transmission of additional HARQ feedback information associated with additional sidelink transmissions.

In some aspects, the first sidelink HARQ timing offset indication may include the applicable or inapplicable sidelink offset value based on a feedback time period between a sidelink feedback resource associated with receipt of the first sidelink HARQ feedback information and an uplink control channel resource associated with transmission of uplink HARQ feedback information.

In some aspects, the first sidelink HARQ timing offset indication may include the inapplicable sidelink offset value based on the feedback time period satisfying a timing threshold. The feedback time period may be, for example, a feedback time period between a sidelink feedback resource associated with receipt of sidelink HARQ feedback information associated with the inapplicable sidelink offset value and an uplink control channel resource associated with transmission of uplink HARQ feedback information that includes the sidelink HARQ feedback information (e.g., a PSFCH-to-PUCCH feedback time period). In some aspects, the network node 706 may transmit, and the UE 702 may receive, configuration information that indicates the timing threshold. The threshold may represent a minimum gap for applying the inapplicable sidelink offset value. In some aspects, for example, if the timing gap satisfies the threshold (e.g., is larger than the threshold), the inapplicable sidelink offset value may be applied. In some aspects, the first sidelink HARQ timing offset indication may include the applicable sidelink offset value based on the feedback time period failing to satisfy the timing threshold.

In some aspects, as shown by reference number 712, the network node 706 may transmit, and the UE 702 may receive, second control information (e.g., DCI). The second control information may include a second sidelink HARQ timing offset configuration indication that indicates a disabled state of the inapplicable sidelink offset value (e.g., if the first sidelink HARQ timing offset configuration indication indicated an enabled state of the inapplicable sidelink offset value). For example, in some aspects, the second sidelink HARQ timing offset configuration may include a second uplink HARQ timing offset indication having an applicable uplink offset value.

In some aspects, as shown by reference number 714, the UE 702 may transmit, and the UE 704 may receive, second SCI. In some aspects, the UE 702 may transmit the second SCI based on receiving the second control information. The second SCI may include a second sidelink HARQ timing offset indication for transmission of second sidelink HARQ feedback information associated with a second sidelink transmission. In some aspects, for example, the second sidelink HARQ timing offset indication may include, based on the second uplink HARQ timing offset indication having the applicable uplink offset value, an applicable sidelink offset value.

As shown by reference number 716, the UE 704 may transmit, and the UE 702 may receive, sidelink HARQ feedback information and, as shown by reference number 718, the UE 702 may transmit, and the network node 706 may receive, uplink HARQ feedback information. For example, in some aspects, the UE 702 may receive the first sidelink HARQ feedback information based on the first sidelink HARQ timing offset indication (or a second sidelink HARQ timing offset indication) comprising the applicable sidelink offset value and may transmit, via an uplink control channel and based on the first control information, uplink HARQ feedback information that includes the first sidelink HARQ feedback information. In some aspects, the UE 702 may receive the first sidelink HARQ feedback information based on the second sidelink HARQ timing offset configuration indication indicating the disabled state of the inapplicable sidelink offset value. The UE 702 may transmit the uplink HARQ feedback information including the first sidelink HARQ feedback information and second sidelink HARQ feedback information associated with a second sidelink transmission.

In some cases, the network node 706 may not directly control the UE 704 intended for allocated transmission resources. Thus, the UE 702 may use the inapplicable sidelink offset value in association with the UE 704, but the second control information may be used for an additional UE. In this case, when the valid PUCCH is to be transmitted, the sidelink HARQ feedback information may not be available. In some aspects, a wireless communication standard and/or a configuration may indicate that a case in which the UE 702 fails to collect sidelink HARQ feedback information for a previous inapplicable sidelink offset value, if an applicable sidelink offset value is provided, is an invalid case. For example, the wireless communication standard and/or the configuration may indicate that, if the second control information indicates an applicable sidelink offset indication value, the UE 702 must transmit the applicable sidelink offset indication value to the UE 704.

In some aspects, the uplink HARQ feedback information may include a negative HARQ acknowledgment associated with sidelink HARQ feedback information based on the UE 702 not receiving the sidelink HARQ feedback information prior to occurrence of a first time associated with a first uplink control channel resource allocated for transmission of the uplink HARQ feedback information. For example, the second control information may include a retransmission resource associated with the negative HARQ acknowledgment, but the UE 702 may refrain from performing a retransmission associated with the sidelink HARQ feedback information based on the UE 702 not receiving the sidelink HARQ feedback information prior to occurrence of a time associated with the retransmission resource. Based on receiving the sidelink HARQ feedback information, wherein the second sidelink HARQ feedback information includes a negative HARQ acknowledgment, the UE 702 may perform a retransmission associated with the negative HARQ acknowledgment.

In some aspects, the sidelink HARQ feedback information may include a HARQ-ACK codebook comprising at least one HARQ-ACK bit and at least one applicability indication. The at least one applicability indication may include an applicability bitmap including at least one applicability bit. Each applicability bit of the at least one applicability bit may be associated with a respective HARQ-ACK bit of the at least one HARQ-ACK bit. For example, for each HARQ-ACK bit, the applicability indication may indicate whether the HARQ-ACK bit is associated with an applicable sidelink offset value or an inapplicable sidelink offset value. In some aspects, each HARQ-ACK field of the HARQ-ACK codebook may include a combination of two bits of a set of combination options. The set of combination options may include a first combination option (e.g., “00”) that indicates an ACK, a second combination option (e.g., “01”) that indicates a NACK, and a third combination option (e.g., “10”) that indicates a HARQ-ACK associated with the inapplicable sidelink offset value. In some aspects, the fourth combination option (e.g., “11”) may be a spare indication.

As indicated above, FIG. 7A is provided as an example. Other examples may differ from what is described with respect to FIG. 7A.

FIG. 7B is a diagram illustrating another example 720 associated with reporting sidelink HARQ feedback information, in accordance with the present disclosure. Example 720 depicts example communications performed by the UE 702, the UE 704, and the network node 706 depicted in FIG. 7A.

As shown in FIG. 7B, the network node 706 may transmit DCI 3_0 to the UE 702 including an uplink HARQ timing offset indication having an inapplicable uplink offset value (“timing=−1”). Based on the inapplicable uplink offset value, the UE 702 may use an inapplicable sidelink offset value to defer HARQ feedback reception. For example, as shown, the UE 702 may transmit a sidelink transmission using resources allocated by the DCI 3_0, indicating a sidelink timing offset value of 4 for a first HARQ process, a timing offset value of 3 for a second HARQ process, a timing offset value of 2 for a third HARQ process, and a timing offset value of −1 (an inapplicable timing offset value) for a fourth HARQ process and a fifth HARQ process. The UE 704 may report sidelink HARQ feedback information (e.g., three ACKs, each shown as “A”) associated with the first through third HARQ processes in a next PSFCH. The sidelink HARQ feedback information associated with the fourth and fifth HARQ processes may be deferred based on the inapplicable sidelink offset value.

The network node 706 may subsequently transmit a DCI 3_0 having an uplink timing offset value of 3 (e.g., an applicable uplink timing offset value), which indicates a PSFCH-to-PUCCH feedback timing. The UE 702 may receive, within an allowed duration for HARQ-ACK associated with inapplicable sidelink timing offset values, sidelink HARQ feedback information associated with the deferred HARQ processes and, in some cases, as shown, additional HARQ processes. The UE 702 may transmit uplink HARQ feedback information in a PUCCH allocated by the second DCI 3_0.

As indicated above, FIG. 7B is provided as an example. Other examples may differ from what is described with respect to FIG. 7B.

FIG. 7C is a diagram illustrating another example 722 associated with reporting sidelink HARQ feedback information, in accordance with the present disclosure. Example 722 depicts example communications performed by the UE 702, the UE 704, and the network node 706 depicted in FIGS. 7A and 7B.

As shown in FIG. 7C, the network node 706 may transmit DCI 3_0 to the UE 702 including an uplink HARQ timing offset indication having an inapplicable uplink offset value (“timing=−1”). Based on the inapplicable uplink offset value, the UE 702 may use an inapplicable sidelink offset value to defer HARQ feedback reception. For example, as shown, the UE 702 may transmit a sidelink transmission using resources allocated by the DCI 3_0, indicating a sidelink timing offset value of 4 for a first HARQ process, a timing offset value of 3 for a second HARQ process, a timing offset value of 2 for a third HARQ process, and a timing offset value of −1 (an inapplicable timing offset value) for a fourth HARQ process and a fifth HARQ process. The UE 704 may report sidelink HARQ feedback information (e.g., two ACKs, each shown as “A,” and a NACK, shown as “N”) associated with the first through third HARQ processes in a next PSFCH. The sidelink HARQ feedback information associated with the fourth and fifth HARQ processes may be deferred based on the inapplicable sidelink offset value.

The UE 702 may transmit first uplink HARQ feedback information (shown as “uplink feedback (PUCCH)”) that includes the ACK/NACK for each of the first three HARQ processes. The first uplink HARQ feedback information may include a NACK associated with each of the HARQ processes associated with the inapplicable sidelink offset value based on a failure to receive sidelink HARQ feedback information associated with those HARQ processes (since they were deferred based on the inapplicable sidelink offset value). Based on receiving three NACKs (the NACK associated with one of the first three HARQ processes and the two NACKs associated with the deferred HARQ processes), the network node 706 may transmit a DCI 3_0 that includes a resource allocation of retransmission resources for three slots.

However, because the UE 702 has not received the sidelink HARQ feedback information associated with the two deferred HARQ processes, the UE 702 may transmit, to the UE 704, a sidelink transmission including SCI that indicates retransmission resources for one slot. The SCI may include an applicable sidelink offset value indicating a next PSFCH, and the UE 704 may transmit, in the PSFCH, sidelink HARQ feedback information associated with the retransmission as well as sidelink HARQ feedback information associated with the deferred HARQ processes. As shown, the UE 702 may transmit uplink HARQ feedback information including the sidelink HARQ feedback information associated with the retransmission and the deferred HARQ processes.

As indicated above, FIG. 7C is provided as an example. Other examples may differ from what is described with respect to FIG. 7C.

FIG. 7D is a diagram illustrating another example 724 associated with reporting sidelink HARQ feedback information, in accordance with the present disclosure. Example 724 depicts example communications performed by the UE 702, the UE 704, and the network node 706 depicted in FIGS. 7A and 7B.

As shown in FIG. 7D, the UE 704 may transmit, to the UE 702, first sidelink HARQ feedback information associated with a previously received sidelink transmission, and the UE 702 may transmit uplink HARQ sidelink information that includes the sidelink HARQ feedback information. As shown, the uplink HARQ feedback information may include a HARQ-ACK codebook that includes an ACK/NACK for each of five HARQ processes. Two of the HARQ processes may indicate NACKs based on being associated with an inapplicable sidelink offset value (and, thus, deferred). The uplink HARQ feedback information also may include a set of applicability indications. The set of applicability indications may include at least one applicability indication. Each applicability indication of the set may be associated with a respective ACK/NACK of the HARQ-ACK codebook. For example, the set of applicability indications may include a bitmap in which a value of 1 indicates that the associated ACK/NACK is associated with an applicable sidelink offset value and a value of 0 indicates that the associated ACK/NACK is associated with an inapplicable sidelink offset value (e.g., K=−1).

The network node 706 may transmit first DCI 3_0 (DCI 3_0 #1) to allocate resources for a PSSCH transmission and second DCI 3_0 K1 (DCI 3_0 #2) to indicate the timing for PSFCH-to-PUCCH feedback used for HARQ-ACK feedback associated with the inapplicable sidelink offset value. The UE 702 may receive, from the UE 704, second sidelink HARQ feedback information that includes a HARQ-ACK codebook associated with the inapplicable sidelink offset value as well as a HARQ-ACK codebook associated with the PSSCH transmission. The UE 702 may transmit, to the network node 706, uplink HARQ feedback information that includes a HARQ-ACK codebook that includes only an ACK/NACK associated with each slot of the PSSCH transmission (e.g., the HARQ-ACK codebook does not include any ACK/NACK associated with the deferred HARQ processes associated with the inapplicable sidelink offset value). The UE 702 may report the HARQ-ACK feedback associated with the deferred HARQ processes in a PUCCH indicated in the DCI 3_0 #2. As shown, the HARQ-ACK feedback associated with the deferred HARQ processes may be reported along with HARQ-ACK feedback associated with a second PSSCH transmission transmitted by the UE 702 using resources allocated in a third DCI 3_0 (DCI 3_0 #3).

In some aspects, the occasion during which the network node 706 transmits the DCI 3_0 #1 and/or the DCI 30 #2 may be determined by the network node 706. In some aspects, the network node 706 may transmit multiple DCI 3_0 #1s, followed by one DCI 3_0 #2. If the PUCCH indicated in DCI 3_0 #2 has the same slot as the PUCCH indicated in DCI 3_0 #1, the HARQ-ACK feedback can be multiplexed. In some aspects, the DCI 3_0 #2 may be a dedicated DCI transmission that only indicates the PSFCH-to-PUCCH feedback timing to be used for reporting the sidelink HARQ feedback information associated with the inapplicable sidelink offset value. For example, each of the FDRA fields included in the DCI 3_0 #2 may include a value of 1.

As indicated above, FIG. 7D is provided as an example. Other examples may differ from what is described with respect to FIG. 7D.

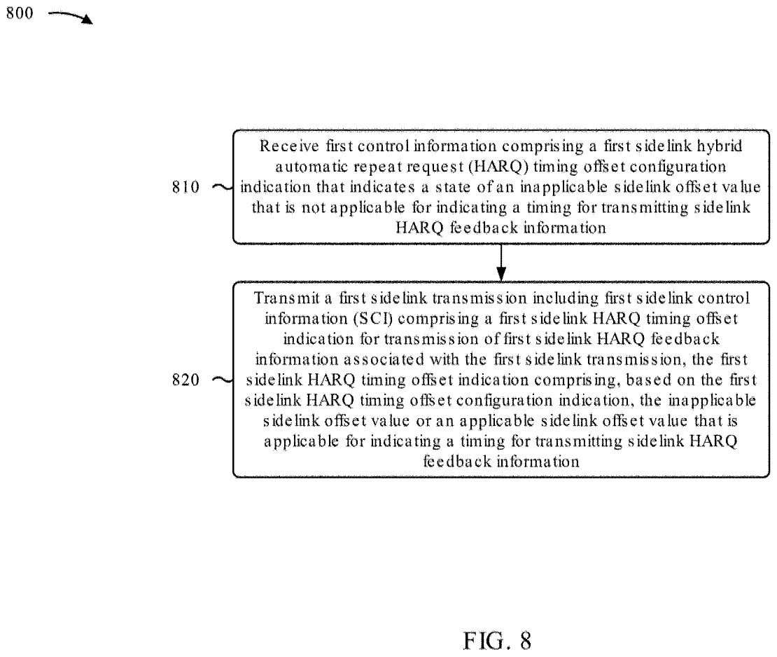

FIG. 8 is a diagram illustrating an example process 800 performed, for example, by a UE, in accordance with the present disclosure. Example process 800 is an example where the UE (e.g., UE 702) performs operations associated with reporting sidelink HARQ feedback information.

As shown in FIG. 8, in some aspects, process 800 may include receiving first control information comprising a first sidelink HARQ timing offset configuration indication that indicates a state of an inapplicable sidelink offset value that is not applicable for indicating a timing for transmitting sidelink HARQ feedback information (block 810). For example, the UE (e.g., using reception component 1602 and/or communication manager 1606, depicted in FIG. 16) may receive first control information comprising a first sidelink HARQ timing offset configuration indication that indicates a state of an inapplicable sidelink offset value that is not applicable for indicating a timing for transmitting sidelink HARQ feedback information, as described above.

As further shown in FIG. 8, in some aspects, process 800 may include transmitting a first sidelink transmission including first sidelink control information (SCI) comprising a first sidelink HARQ timing offset indication for transmission of first sidelink HARQ feedback information associated with the first sidelink transmission, the first sidelink HARQ timing offset indication comprising, based on the first sidelink HARQ timing offset configuration indication, the inapplicable sidelink offset value or an applicable sidelink offset value that is applicable for indicating a timing for transmitting sidelink HARQ feedback information (block 820). For example, the UE (e.g., using transmission component 1604 and/or communication manager 1606, depicted in FIG. 16) may transmit a first sidelink transmission including first sidelink control information (SCI) comprising a first sidelink HARQ timing offset indication for transmission of first sidelink HARQ feedback information associated with the first sidelink transmission, the first sidelink HARQ timing offset indication comprising, based on the first sidelink HARQ timing offset configuration indication, the inapplicable sidelink offset value or an applicable sidelink offset value that is applicable for indicating a timing for transmitting sidelink HARQ feedback information, as described above.

Process 800 may include additional aspects, such as any single aspect or any combination of aspects described below and/or in connection with one or more other processes described elsewhere herein.

In a first aspect, receiving the first control information comprises receiving first downlink control information. In a second aspect, alone or in combination with the first aspect, the first sidelink HARQ timing offset configuration includes an uplink HARQ timing offset indication. In a third aspect, alone or in combination with one or more of the first and second aspects, the uplink HARQ timing offset indication has an applicable uplink offset value that is applicable for indicating a timing for transmitting uplink HARQ feedback information, and the first sidelink HARQ timing offset indication comprises the applicable sidelink offset value based on the uplink HARQ timing offset indication having the applicable uplink offset value. In a fourth aspect, alone or in combination with one or more of the first through third aspects, process 800 includes receiving the first sidelink HARQ feedback information based on the first sidelink HARQ timing offset indication comprising the applicable sidelink offset value, and transmitting, via an uplink control channel and based on the first control information, uplink HARQ feedback information comprising the first sidelink HARQ feedback information.

In a fifth aspect, alone or in combination with one or more of the first through fourth aspects, the uplink HARQ timing offset indication has an inapplicable uplink offset value that is not applicable for indicating a timing for transmitting uplink HARQ feedback information, and the first sidelink HARQ timing offset indication comprises the inapplicable sidelink offset value based on the uplink HARQ timing offset indication having the inapplicable uplink offset value. In a sixth aspect, alone or in combination with one or more of the first through fifth aspects, process 800 includes receiving second control information comprising a second sidelink HARQ timing offset configuration indication that indicates a disabled state of the inapplicable sidelink offset value, receiving the first sidelink HARQ feedback information based on the second sidelink HARQ timing offset configuration indication indicating the disabled state of the inapplicable sidelink offset value, and transmitting, via an uplink control channel and based on the second control information, uplink HARQ feedback information comprising the first sidelink HARQ feedback information and second sidelink HARQ feedback information associated with a second sidelink transmission, the uplink HARQ feedback information comprising the first sidelink HARQ feedback information based on the first control information. In a seventh aspect, alone or in combination with one or more of the first through sixth aspects, receiving the second control information comprises receiving second downlink control information.

In an eighth aspect, alone or in combination with one or more of the first through seventh aspects, the second sidelink HARQ timing offset configuration comprises a second uplink HARQ timing offset indication having an applicable uplink offset value that is applicable for indicating a timing for transmitting the uplink HARQ feedback information. In a ninth aspect, alone or in combination with one or more of the first through eighth aspects, transmitting the first sidelink transmission including the first SCI comprises transmitting the first SCI to a receiving UE, and process 800 includes transmitting, to the receiving UE based on receiving the second control information, second SCI comprising a second sidelink HARQ timing offset indication for transmission of second sidelink HARQ feedback information associated with a second sidelink transmission, the second sidelink HARQ timing offset indication comprising, based on the second uplink HARQ timing offset indication having the applicable uplink offset value, an applicable sidelink offset value.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

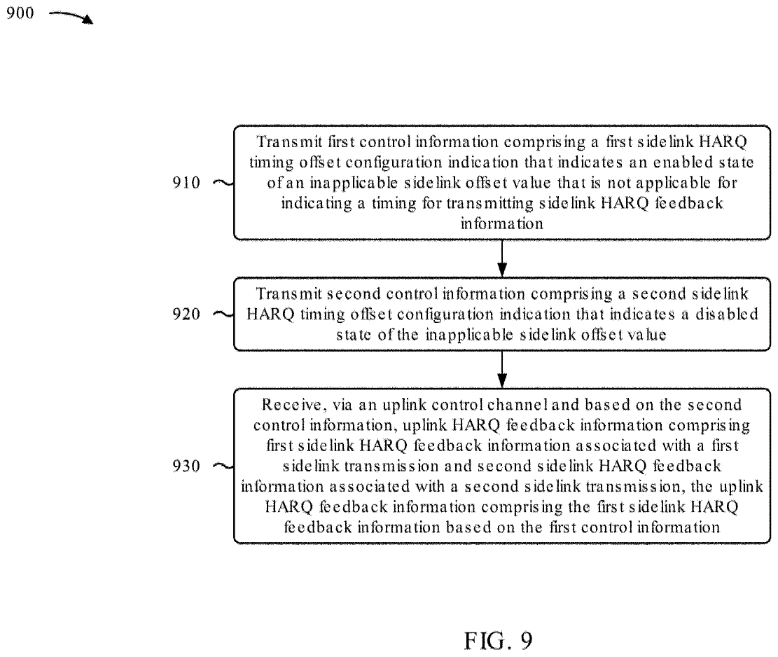

FIG. 9 is a diagram illustrating an example process 900 performed, for example, by a network node, in accordance with the present disclosure. Example process 900 is an example where the network node (e.g., network node 706) performs operations associated with reporting sidelink HARQ feedback information.

As shown in FIG. 9, in some aspects, process 900 may include transmitting first control information comprising a first sidelink HARQ timing offset configuration indication that indicates an enabled state of an inapplicable sidelink offset value that is not applicable for indicating a timing for transmitting sidelink HARQ feedback information (block 910). For example, the network node (e.g., using transmission component 1704 and/or communication manager 1706, depicted in FIG. 17) may transmit first control information comprising a first sidelink HARQ timing offset configuration indication that indicates an enabled state of an inapplicable sidelink offset value that is not applicable for indicating a timing for transmitting sidelink HARQ feedback information, as described above.

As further shown in FIG. 9, in some aspects, process 900 may include transmitting second control information comprising a second sidelink HARQ timing offset configuration indication that indicates a disabled state of the inapplicable sidelink offset value (block 920). For example, the network node (e.g., using transmission component 1704 and/or communication manager 1706, depicted in FIG. 17) may transmit second control information comprising a second sidelink HARQ timing offset configuration indication that indicates a disabled state of the inapplicable sidelink offset value, as described above.

As further shown in FIG. 9, in some aspects, process 900 may include receiving, via an uplink control channel and based on the second control information, uplink HARQ feedback information comprising first sidelink HARQ feedback information associated with a first sidelink transmission and second sidelink HARQ feedback information associated with a second sidelink transmission, the uplink HARQ feedback information comprising the first sidelink HARQ feedback information based on the first control information (block 930). For example, the network node (e.g., using reception component 1702 and/or communication manager 1706, depicted in FIG. 17) may receive, via an uplink control channel and based on the second control information, uplink HARQ feedback information comprising first sidelink HARQ feedback information associated with a first sidelink transmission and second sidelink HARQ feedback information associated with a second sidelink transmission, the uplink HARQ feedback information comprising the first sidelink HARQ feedback information based on the first control information, as described above.

Process 900 may include additional aspects, such as any single aspect or any combination of aspects described below and/or in connection with one or more other processes described elsewhere herein.

In a first aspect, transmitting the first control information comprises transmitting first downlink control information. In a second aspect, alone or in combination with the first aspect, transmitting the second control information comprises transmitting second downlink control information. In a third aspect, alone or in combination with one or more of the first and second aspects, the second sidelink HARQ timing offset configuration comprises a second uplink HARQ timing offset indication having an applicable uplink offset value that is applicable for indicating a timing for transmitting the uplink HARQ feedback information.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by a UE, in accordance with the present disclosure. Example process 1000 is an example where the UE (e.g., UE 702) performs operations associated with reporting sidelink HARQ feedback information.

As shown in FIG. 10, in some aspects, process 1000 may include transmitting a first sidelink transmission including first SCI comprising a first sidelink HARQ timing offset indication for transmission of first sidelink HARQ feedback information associated with the first sidelink transmission, the first sidelink HARQ timing offset indication comprising, based on a feedback time period between a sidelink feedback resource associated with receipt of the first sidelink HARQ feedback information and an uplink control channel resource associated with transmission of uplink HARQ feedback information, an inapplicable sidelink offset value that is not applicable for indicating a timing for transmitting sidelink HARQ feedback information or an applicable sidelink offset value that is applicable for indicating a timing for transmitting sidelink HARQ feedback information (block 1010). For example, the UE (e.g., using transmission component 1604 and/or communication manager 1606, depicted in FIG. 16) may transmit a first sidelink transmission including first SCI comprising a first sidelink HARQ timing offset indication for transmission of first sidelink HARQ feedback information associated with the first sidelink transmission, the first sidelink HARQ timing offset indication comprising, based on a feedback time period between a sidelink feedback resource associated with receipt of the first sidelink HARQ feedback information and an uplink control channel resource associated with transmission of uplink HARQ feedback information, an inapplicable sidelink offset value that is not applicable for indicating a timing for transmitting sidelink HARQ feedback information or an applicable sidelink offset value that is applicable for indicating a timing for transmitting sidelink HARQ feedback information, as described above.

As further shown in FIG. 10, in some aspects, process 1000 may include receiving the first sidelink HARQ feedback information based on the first SCI or second SCI comprising a second sidelink HARQ timing offset indication having an applicable sidelink offset value (block 1020). For example, the UE (e.g., using reception component 1602 and/or communication manager 1606, depicted in FIG. 16) may receive the first sidelink HARQ feedback information based on the first SCI or second SCI comprising a second sidelink HARQ timing offset indication having an applicable sidelink offset value, as described above.

Process 1000 may include additional aspects, such as any single aspect or any combination of aspects described below and/or in connection with one or more other processes described elsewhere herein.

In a first aspect, process 1000 includes receiving first control information comprising an uplink HARQ timing offset indication having an applicable uplink offset value that is applicable for indicating a timing for transmitting uplink HARQ feedback information, and transmitting, based on the first control information and based on receiving the first sidelink HARQ feedback information, uplink HARQ feedback information comprising the first sidelink HARQ feedback information. In a second aspect, alone or in combination with the first aspect, the first sidelink HARQ timing offset indication comprises the inapplicable sidelink offset value based on the feedback time period satisfying a timing threshold. In a third aspect, alone or in combination with one or more of the first and second aspects, process 1000 includes receiving configuration information that indicates the timing threshold. In a fourth aspect, alone or in combination with one or more of the first through third aspects, the first sidelink HARQ timing offset indication comprises the applicable sidelink offset value based on the feedback time period failing to satisfy a timing threshold.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, by a network node, in accordance with the present disclosure. Example process 1100 is an example where the network node (e.g., network node 706) performs operations associated with reporting sidelink HARQ feedback information.

As shown in FIG. 11, in some aspects, process 1100 may include transmitting, to a UE, first control information comprising an uplink HARQ timing offset indication having an applicable uplink offset value that is applicable for indicating a timing for transmitting uplink HARQ feedback information (block 1110). For example, the network node (e.g., using transmission component 1704 and/or communication manager 1706, depicted in FIG. 19) may transmit, to a UE, first control information comprising an uplink HARQ timing offset indication having an applicable uplink offset value that is applicable for indicating a timing for transmitting uplink HARQ feedback information, as described above.

As further shown in FIG. 11, in some aspects, process 1100 may include receiving, from the UE and based on the first control information, uplink HARQ feedback information comprising first sidelink HARQ feedback information, the uplink HARQ feedback information comprising the first sidelink HARQ feedback information based on: first sidelink control information comprising a first sidelink HARQ timing offset indication having, based on a feedback time period between a sidelink feedback resource associated with receipt of the first sidelink HARQ feedback information and an uplink control channel resource associated with transmission of the uplink HARQ feedback information, an applicable sidelink offset value that is applicable for indicating a timing for transmitting sidelink HARQ feedback information, or second SCI comprising a second sidelink HARQ timing offset indication having an applicable sidelink offset value (block 1120). For example, the network node (e.g., using reception component 1702 and/or communication manager 1706, depicted in FIG. 17) may receive, from the UE and based on the first control information, uplink HARQ feedback information comprising first sidelink HARQ feedback information, the uplink HARQ feedback information comprising the first sidelink HARQ feedback information based on: first sidelink control information comprising a first sidelink HARQ timing offset indication having, based on a feedback time period between a sidelink feedback resource associated with receipt of the first sidelink HARQ feedback information and an uplink control channel resource associated with transmission of the uplink HARQ feedback information, an applicable sidelink offset value that is applicable for indicating a timing for transmitting sidelink HARQ feedback information, or second SCI comprising a second sidelink HARQ timing offset indication having an applicable sidelink offset value, as described above.

Process 1100 may include additional aspects, such as any single aspect or any combination of aspects described below and/or in connection with one or more other processes described elsewhere herein.

In a first aspect, the uplink HARQ feedback information comprises the first sidelink HARQ feedback information based on the second SCI comprising a second sidelink HARQ timing offset indication having an applicable sidelink offset value, and the first sidelink HARQ timing offset indication comprises an inapplicable sidelink offset value, that is not applicable for indicating a timing for transmitting sidelink HARQ feedback information, based on the feedback time period satisfying a timing threshold. In a second aspect, alone or in combination with the first aspect, process 1100 includes transmitting configuration information that indicates the timing threshold. In a third aspect, alone or in combination with one or more of the first and second aspects, the uplink HARQ feedback information comprises the first sidelink HARQ feedback information based on the first sidelink control information comprising a first sidelink HARQ timing offset indication having the applicable sidelink offset value, and the first sidelink HARQ timing offset indication comprises the applicable sidelink offset value based on the feedback time period failing to satisfy a timing threshold.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram illustrating an example process 1200 performed, for example, by a UE, in accordance with the present disclosure. Example process 1200 is an example where the UE (e.g., UE 702) performs operations associated with reporting sidelink HARQ feedback information.

As shown in FIG. 12, in some aspects, process 1200 may include transmitting a first sidelink transmission including first SCI comprising a first sidelink HARQ timing offset indication for transmission of first sidelink HARQ feedback information associated with a first sidelink transmission and a second sidelink HARQ timing offset indication for transmission of second sidelink HARQ feedback information associated with a second sidelink transmission, the first sidelink HARQ timing offset indication comprising an applicable sidelink offset value that is applicable for indicating a timing for transmitting sidelink HARQ feedback information, and the second sidelink HARQ timing offset indication comprising an inapplicable sidelink offset value that is not applicable for indicating a timing for transmitting sidelink HARQ feedback information (block 1210). For example, the UE (e.g., using transmission component 1604 and/or communication manager 1606, depicted in FIG. 16) may transmit a first sidelink transmission including first SCI comprising a first sidelink HARQ timing offset indication for transmission of first sidelink HARQ feedback information associated with a first sidelink transmission and a second sidelink HARQ timing offset indication for transmission of second sidelink HARQ feedback information associated with a second sidelink transmission, the first sidelink HARQ timing offset indication comprising an applicable sidelink offset value that is applicable for indicating a timing for transmitting sidelink HARQ feedback information, and the second sidelink HARQ timing offset indication comprising an inapplicable sidelink offset value that is not applicable for indicating a timing for transmitting sidelink HARQ feedback information, as described above.

As further shown in FIG. 12, in some aspects, process 1200 may include receiving the first sidelink HARQ feedback information (block 1220). For example, the UE (e.g., using reception component 1602 and/or communication manager 1606, depicted in FIG. 16) may receive the first sidelink HARQ feedback information, as described above.

As further shown in FIG. 12, in some aspects, process 1200 may include transmitting, via an uplink control channel, first uplink HARQ feedback information comprising the first sidelink HARQ feedback information, the first uplink HARQ feedback information further comprising a negative HARQ acknowledgment associated with the second sidelink HARQ feedback information based on the UE not receiving the second sidelink HARQ feedback information prior to occurrence of a first time associated with a first uplink control channel resource allocated for transmission of the first uplink HARQ feedback information (block 1230). For example, the UE (e.g., using transmission component 1604 and/or communication manager 1606, depicted in FIG. 16) may transmit, via an uplink control channel, first uplink HARQ feedback information comprising the first sidelink HARQ feedback information, the first uplink HARQ feedback information further comprising a negative HARQ acknowledgment associated with the second sidelink HARQ feedback information based on the UE not receiving the second sidelink HARQ feedback information prior to occurrence of a first time associated with a first uplink control channel resource allocated for transmission of the first uplink HARQ feedback information, as described above.

Process 1200 may include additional aspects, such as any single aspect or any combination of aspects described below and/or in connection with one or more other processes described elsewhere herein.

In a first aspect, process 1200 includes receiving control information indicating a retransmission resource associated with the negative HARQ acknowledgment, and refraining from performing a retransmission associated with the second sidelink HARQ feedback information based on the UE not receiving the second sidelink HARQ feedback information prior to occurrence of a time associated with the retransmission resource. In a second aspect, alone or in combination with the first aspect, process 1200 includes receiving the second sidelink HARQ feedback information, wherein the second sidelink HARQ feedback information comprises a negative HARQ acknowledgment, and performing a retransmission associated with the negative HARQ acknowledgment based on receiving the second sidelink HARQ feedback information.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram illustrating an example process 1300 performed, for example, by a network node, in accordance with the present disclosure. Example process 1300 is an example where the network node (e.g., network node 706) performs operations associated with reporting sidelink HARQ feedback information.

As shown in FIG. 13, in some aspects, process 1300 may include transmitting, to a UE, first control information indicating a first uplink control channel resource associated with transmission of first uplink HARQ feedback information (block 1310). For example, the network node (e.g., using transmission component 1704 and/or communication manager 1706, depicted in FIG. 17) may transmit, to a UE, first control information indicating a first uplink control channel resource associated with transmission of first uplink HARQ feedback information, as described above.

As further shown in FIG. 13, in some aspects, process 1300 may include receiving, from the UE, first uplink HARQ feedback information comprising first sidelink HARQ feedback information associated with a first sidelink transmission, the first uplink HARQ feedback information further comprising a negative HARQ acknowledgment associated with second sidelink HARQ feedback information associated with a second sidelink transmission and based on the UE not receiving the second sidelink HARQ feedback information prior to occurrence of a first time associated with a first uplink control channel resource allocated for transmission of the first uplink HARQ feedback information (block 1320). For example, the network node (e.g., using reception component 1702 and/or communication manager 1706, depicted in FIG. 17) may receive, from the UE, first uplink HARQ feedback information comprising first sidelink HARQ feedback information associated with a first sidelink transmission, the first uplink HARQ feedback information further comprising a negative HARQ acknowledgment associated with second sidelink HARQ feedback information associated with a second sidelink transmission and based on the UE not receiving the second sidelink HARQ feedback information prior to occurrence of a first time associated with a first uplink control channel resource allocated for transmission of the first uplink HARQ feedback information, as described above.

Process 1300 may include additional aspects, such as any single aspect or any combination of aspects described below and/or in connection with one or more other processes described elsewhere herein.

In a first aspect, process 1300 includes transmitting second control information indicating a second uplink control channel resource, and receiving, based on the second control information, second uplink HARQ feedback information comprising the second sidelink HARQ feedback information.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

FIG. 14 is a diagram illustrating an example process 1400 performed, for example, by a UE, in accordance with the present disclosure. Example process 1400 is an example where the UE (e.g., UE 702) performs operations associated with reporting sidelink HARQ feedback information.

As shown in FIG. 14, in some aspects, process 1400 may include transmitting a first sidelink transmission including first SCI comprising a first sidelink HARQ timing offset indication for transmission of first sidelink HARQ feedback information associated with at least one sidelink transmission, the first sidelink HARQ timing offset indication comprising an inapplicable sidelink offset value that is not applicable for indicating a timing for transmitting sidelink HARQ feedback information or an applicable sidelink offset value that is applicable for indicating a timing for transmitting sidelink HARQ feedback information (block 1410). For example, the UE (e.g., using transmission component 1604 and/or communication manager 1606, depicted in FIG. 16) may transmit a first sidelink transmission including first SCI comprising a first sidelink HARQ timing offset indication for transmission of first sidelink HARQ feedback information associated with at least one sidelink transmission, the first sidelink HARQ timing offset indication comprising an inapplicable sidelink offset value that is not applicable for indicating a timing for transmitting sidelink HARQ feedback information or an applicable sidelink offset value that is applicable for indicating a timing for transmitting sidelink HARQ feedback information, as described above.

As further shown in FIG. 14, in some aspects, process 1400 may include receiving the first sidelink HARQ feedback information (block 1420). For example, the UE (e.g., using reception component 1602 and/or communication manager 1606, depicted in FIG. 16) may receive the first sidelink HARQ feedback information, as described above.

As further shown in FIG. 14, in some aspects, process 1400 may include transmitting, via an uplink control channel, first uplink HARQ feedback information comprising the first sidelink HARQ feedback information, the first uplink HARQ feedback information comprising a HARQ-acknowledgment (HARQ-ACK) codebook including at least one applicability indication associated with at least one HARQ-ACK of the first sidelink HARQ feedback information, the at least one applicability indication indicating whether the at least one HARQ-ACK is associated with the applicable sidelink offset value or the inapplicable sidelink offset value (block 1430). For example, the UE (e.g., using transmission component 1604 and/or communication manager 1606, depicted in FIG. 16) may transmit, via an uplink control channel, first uplink HARQ feedback information comprising the first sidelink HARQ feedback information, the first uplink HARQ feedback information comprising a HARQ-ACK codebook including at least one applicability indication associated with at least one HARQ-ACK of the first sidelink HARQ feedback information, the at least one applicability indication indicating whether the at least one HARQ-ACK is associated with the applicable sidelink offset value or the inapplicable sidelink offset value, as described above.

Process 1400 may include additional aspects, such as any single aspect or any combination of aspects described below and/or in connection with one or more other processes described elsewhere herein.

In a first aspect, the first sidelink HARQ feedback information comprises a HARQ-ACK codebook comprising at least one HARQ-ACK bit, and the at least one applicability indication comprises an applicability bitmap comprising at least one applicability bit, each applicability bit of the at least one applicability bit being associated with a respective HARQ-ACK bit of the at least one HARQ-ACK bit. In a second aspect, alone or in combination with the first aspect, the first sidelink HARQ feedback information comprises a HARQ-ACK codebook comprising at least one HARQ-ACK field, each HARQ-ACK field including a combination of two bits of a set of combination options, the set of combination options comprising a first combination option that indicates an acknowledgment (ACK), a second combination option that indicates a negative acknowledgment (NACK), and a third combination option that indicates a HARQ-ACK associated with the inapplicable sidelink offset value.

In a third aspect, alone or in combination with one or more of the first and second aspects, process 1400 includes receiving a resource allocation comprising an allocation of retransmission resources based on the at least one applicability indication. In a fourth aspect, alone or in combination with one or more of the first through third aspects, the allocation of retransmission resources indicates at least one retransmission resource allocated for retransmission of a sidelink transmission of the at least one sidelink transmission based on the at least one applicability indication indicating that a HARQ-ACK associated with the sidelink transmission is associated with the applicable sidelink offset value.

In a fifth aspect, alone or in combination with one or more of the first through fourth aspects, the at least one applicability indication indicates that the at least one HARQ-ACK is associated with an inapplicable sidelink offset value, and process 1400 includes receiving first DCI that indicates a feedback time period between a sidelink feedback resource associated with receipt of second sidelink HARQ feedback information associated with the inapplicable sidelink offset value and an uplink control channel resource associated with transmission of second uplink HARQ feedback information that includes the second sidelink HARQ feedback information, and transmitting the second uplink HARQ feedback information based on the first DCI. In a sixth aspect, alone or in combination with one or more of the first through fifth aspects, the first DCI comprises a dedicated DCI transmission for indicating the feedback time period. In a seventh aspect, alone or in combination with one or more of the first through sixth aspects, the first DCI does not include a resource allocation. In an eighth aspect, alone or in combination with one or more of the first through seventh aspects, the first DCI includes a set of frequency domain resource allocation (FDRA) fields, each FDRA field of the set of FDRA fields including an FDRA value equal to one.

In a ninth aspect, alone or in combination with one or more of the first through eighth aspects, process 1400 includes receiving second DCI that includes a resource allocation associated with at least one additional sidelink transmission, wherein the second uplink HARQ feedback information includes at least one additional HARQ-ACK associated with the at least one additional sidelink transmission.

Although FIG. 14 shows example blocks of process 1400, in some aspects, process 1400 may include additional blocks, fewer blocks, different blocks, or differently arranged blocks than those depicted in FIG. 14. Additionally, or alternatively, two or more of the blocks of process 1400 may be performed in parallel.

FIG. 15 is a diagram illustrating an example process 1500 performed, for example, by a network node, in accordance with the present disclosure. Example process 1500 is an example where the network node (e.g., network node 706) performs operations associated with reporting sidelink HARQ feedback information.

As shown in FIG. 15, in some aspects, process 1500 may include receiving, via an uplink control channel, first uplink HARQ feedback information comprising first sidelink HARQ feedback information associated with at least one sidelink transmission, the first uplink HARQ feedback information comprising a HARQ-ACK codebook including at least one applicability indication associated with at least one HARQ-ACK of the first sidelink HARQ feedback information, the at least one applicability indication indicating whether the at least one HARQ-ACK is associated with an inapplicable sidelink offset value that is not applicable for indicating a timing for transmitting sidelink HARQ feedback information or an applicable sidelink offset value that is applicable for indicating a timing for transmitting sidelink HARQ feedback information (block 1510). For example, the network node (e.g., using reception component 1702 and/or communication manager 1706, depicted in FIG. 17) may receive, via an uplink control channel, first uplink HARQ feedback information comprising first sidelink HARQ feedback information associated with at least one sidelink transmission, the first uplink HARQ feedback information comprising a HARQ-ACK codebook including at least one applicability indication associated with at least one HARQ-ACK of the first sidelink HARQ feedback information, the at least one applicability indication indicating whether the at least one HARQ-ACK is associated with an inapplicable sidelink offset value that is not applicable for indicating a timing for transmitting sidelink HARQ feedback information or an applicable sidelink offset value that is applicable for indicating a timing for transmitting sidelink HARQ feedback information, as described above.

As further shown in FIG. 15, in some aspects, process 1500 may include transmitting a resource allocation comprising an allocation of retransmission resources based on the at least one applicability indication (block 1520). For example, the network node (e.g., using transmission component 1704 and/or communication manager 1706, depicted in FIG. 17) may transmit a resource allocation comprising an allocation of retransmission resources based on the at least one applicability indication, as described above.

Process 1500 may include additional aspects, such as any single aspect or any combination of aspects described below and/or in connection with one or more other processes described elsewhere herein.

In a first aspect, the allocation of retransmission resources indicates at least one retransmission resource allocated for retransmission of a sidelink transmission of the at least one sidelink transmission based on the at least one applicability indication indicating that a HARQ-ACK associated with the sidelink transmission is associated with the applicable sidelink offset value. In a second aspect, alone or in combination with the first aspect, the first sidelink HARQ feedback information comprises a HARQ-ACK codebook comprising at least one HARQ-ACK bit, and the at least one applicability indication comprises an applicability bitmap comprising at least one applicability bit, each applicability bit of the at least one applicability bit being associated with a respective HARQ-ACK bit of the at least one HARQ-ACK bit.

In a third aspect, alone or in combination with one or more of the first and second aspects, the first sidelink HARQ feedback information comprises a HARQ-ACK codebook comprising at least one HARQ-ACK field, each HARQ-ACK field including a combination of two bits of a set of combination options, the set of combination options comprising a first combination option that indicates an ACK, a second combination option that indicates a NACK, and a third combination option that indicates a HARQ-ACK associated with the inapplicable sidelink offset value.

In a fourth aspect, alone or in combination with one or more of the first through third aspects, the at least one applicability indication indicates that the at least one HARQ-ACK is associated with an inapplicable sidelink offset value, and process 1500 includes transmitting first DCI that indicates a feedback time period between a sidelink feedback resource associated with receipt of second sidelink HARQ feedback information associated with the inapplicable sidelink offset value and an uplink control channel resource associated with transmission of second uplink HARQ feedback information that includes the second sidelink HARQ feedback information, and receiving the second uplink HARQ feedback information based on the first DCI.

In a fifth aspect, alone or in combination with one or more of the first through fourth aspects, the first DCI comprises a dedicated DCI transmission for indicating the feedback time period. In a sixth aspect, alone or in combination with one or more of the first through fifth aspects, the first DCI does not include a resource allocation. In a seventh aspect, alone or in combination with one or more of the first through sixth aspects, the first DCI includes a set of FDRA fields, each FDRA field of the set of FDRA fields including an FDRA value equal to one. In an eighth aspect, alone or in combination with one or more of the first through seventh aspects, process 1500 includes transmitting second DCI that includes a resource allocation associated with at least one additional sidelink transmission, wherein the second uplink HARQ feedback information includes at least one additional HARQ-ACK associated with the at least one additional sidelink transmission.

Although FIG. 15 shows example blocks of process 1500, in some aspects, process 1500 may include additional blocks, fewer blocks, different blocks, or differently arranged blocks than those depicted in FIG. 15. Additionally, or alternatively, two or more of the blocks of process 1500 may be performed in parallel.

FIG. 16 is a diagram of an example apparatus 1600 for wireless communication, in accordance with the present disclosure. The apparatus 1600 may be a UE, or a UE may include the apparatus 1600. In some aspects, the apparatus 1600 includes a reception component 1602, a transmission component 1604, and/or a communication manager 1606, which may be in communication with one another (for example, via one or more buses and/or one or more other components). In some aspects, the communication manager 1606 is the communication manager 140 described in connection with FIG. 1. As shown, the apparatus 1600 may communicate with another apparatus 1608, such as a UE or a network node (such as a CU, a DU, an RU, or a base station), using the reception component 1602 and the transmission component 1604.

In some aspects, the apparatus 1600 may be configured to perform one or more operations described herein in connection with FIGS. 7A-7D. Additionally, or alternatively, the apparatus 1600 may be configured to perform one or more processes described herein, such as process 800 of FIG. 8, process 1000 of FIG. 10, process 1200 of FIG. 12, process 1400 of FIG. 14, or a combination thereof. In some aspects, the apparatus 1600 and/or one or more components shown in FIG. 16 may include one or more components of the UE described in connection with FIG. 2. Additionally, or alternatively, one or more components shown in FIG. 16 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1602 may receive communications, such as reference signals, control information, data communications, or a combination thereof, from the apparatus 1608. The reception component 1602 may provide received communications to one or more other components of the apparatus 1600. In some aspects, the reception component 1602 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1600. In some aspects, the reception component 1602 may include one or more antennas, a modem, a demodulator, a MIMO detector, a receive processor, a controller/processor, a memory, or a combination thereof, of the UE described in connection with FIG. 2.

The transmission component 1604 may transmit communications, such as reference signals, control information, data communications, or a combination thereof, to the apparatus 1608. In some aspects, one or more other components of the apparatus 1600 may generate communications and may provide the generated communications to the transmission component 1604 for transmission to the apparatus 1608. In some aspects, the transmission component 1604 may perform signal processing on the generated communications (such as filtering, amplification, modulation, digital-to-analog conversion, multiplexing, interleaving, mapping, or encoding, among other examples), and may transmit the processed signals to the apparatus 1608. In some aspects, the transmission component 1604 may include one or more antennas, a modem, a modulator, a transmit MIMO processor, a transmit processor, a controller/processor, a memory, or a combination thereof, of the UE described in connection with FIG. 2. In some aspects, the transmission component 1604 may be co-located with the reception component 1602 in a transceiver.

The communication manager 1606 may support operations of the reception component 1602 and/or the transmission component 1604. For example, the communication manager 1606 may receive information associated with configuring reception of communications by the reception component 1602 and/or transmission of communications by the transmission component 1604. Additionally, or alternatively, the communication manager 1606 may generate and/or provide control information to the reception component 1602 and/or the transmission component 1604 to control reception and/or transmission of communications.

The reception component 1602 may receive first control information comprising a first sidelink HARQ timing offset configuration indication that indicates a state of an inapplicable sidelink offset value that is not applicable for indicating a timing for transmitting sidelink HARQ feedback information. The transmission component 1604 may transmit a first sidelink transmission including first SCI comprising a first sidelink HARQ timing offset indication for transmission of first sidelink HARQ feedback information associated with the first sidelink transmission, the first sidelink HARQ timing offset indication comprising, based on the first sidelink HARQ timing offset configuration indication, the inapplicable sidelink offset value or an applicable sidelink offset value that is applicable for indicating a timing for transmitting sidelink HARQ feedback information.

The reception component 1602 may receive the first sidelink HARQ feedback information based on the first sidelink HARQ timing offset indication comprising the applicable sidelink offset value. The transmission component 1604 may transmit, via an uplink control channel and based on the first control information, uplink HARQ feedback information comprising the first sidelink HARQ feedback information. The reception component 1602 may receive second control information comprising a second sidelink HARQ timing offset configuration indication that indicates a disabled state of the inapplicable sidelink offset value. The reception component 1602 may receive the first sidelink HARQ feedback information based on the second sidelink HARQ timing offset configuration indication indicating the disabled state of the inapplicable sidelink offset value. The transmission component 1604 may transmit, via an uplink control channel and based on the second control information, uplink HARQ feedback information comprising the first sidelink HARQ feedback information and second sidelink HARQ feedback information associated with a second sidelink transmission, the uplink HARQ feedback information comprising the first sidelink HARQ feedback information based on the first control information.

The transmission component 1604 may transmit a first sidelink transmission including first SCI comprising a first sidelink HARQ timing offset indication for transmission of first sidelink HARQ feedback information associated with the first sidelink transmission, the first sidelink HARQ timing offset indication comprising, based on a feedback time period between a sidelink feedback resource associated with receipt of the first sidelink HARQ feedback information and an uplink control channel resource associated with transmission of uplink HARQ feedback information, an inapplicable sidelink offset value that is not applicable for indicating a timing for transmitting sidelink HARQ feedback information or an applicable sidelink offset value that is applicable for indicating a timing for transmitting sidelink HARQ feedback information. The reception component 1602 may receive the first sidelink HARQ feedback information based on the first SCI or second SCI comprising a second sidelink HARQ timing offset indication having an applicable sidelink offset value.

The reception component 1602 may receive first control information comprising an uplink HARQ timing offset indication having an applicable uplink offset value that is applicable for indicating a timing for transmitting uplink HARQ feedback information. The transmission component 1604 may transmit, based on the first control information and based on receiving the first sidelink HARQ feedback information, uplink HARQ feedback information comprising the first sidelink HARQ feedback information. The reception component 1602 may receive configuration information that indicates the timing threshold.

The transmission component 1604 may transmit a first sidelink transmission including first SCI comprising a first sidelink HARQ timing offset indication for transmission of first sidelink HARQ feedback information associated with a first sidelink transmission and a second sidelink HARQ timing offset indication for transmission of second sidelink HARQ feedback information associated with a second sidelink transmission, the first sidelink HARQ timing offset indication comprising an applicable sidelink offset value that is applicable for indicating a timing for transmitting sidelink HARQ feedback information, and the second sidelink HARQ timing offset indication comprising an inapplicable sidelink offset value that is not applicable for indicating a timing for transmitting sidelink HARQ feedback information. The reception component 1602 may receive the first sidelink HARQ feedback information. The transmission component 1604 may transmit, via an uplink control channel, first uplink HARQ feedback information comprising the first sidelink HARQ feedback information, the first uplink HARQ feedback information further comprising a negative HARQ acknowledgment associated with the second sidelink HARQ feedback information based on the UE not receiving the second sidelink HARQ feedback information prior to occurrence of a first time associated with a first uplink control channel resource allocated for transmission of the first uplink HARQ feedback information.

The reception component 1602 may receive control information indicating a retransmission resource associated with the negative HARQ acknowledgment. The communication manager 1606 may refrain from performing a retransmission associated with the second sidelink HARQ feedback information based on the UE not receiving the second sidelink HARQ feedback information prior to occurrence of a time associated with the retransmission resource. The reception component 1602 may receive the second sidelink HARQ feedback information, wherein the second sidelink HARQ feedback information comprises a negative HARQ acknowledgment. The communication manager 1606 may perform a retransmission associated with the negative HARQ acknowledgment based on receiving the second sidelink HARQ feedback information.

The transmission component 1604 may transmit a first sidelink transmission including first SCI comprising a first sidelink HARQ timing offset indication for transmission of first sidelink HARQ feedback information associated with at least one sidelink transmission, the first sidelink HARQ timing offset indication comprising an inapplicable sidelink offset value that is not applicable for indicating a timing for transmitting sidelink HARQ feedback information or an applicable sidelink offset value that is applicable for indicating a timing for transmitting sidelink HARQ feedback information. The reception component 1602 may receive the first sidelink HARQ feedback information. The transmission component 1604 may transmit, via an uplink control channel, first uplink HARQ feedback information comprising the first sidelink HARQ feedback information, the first uplink HARQ feedback information comprising a HARQ-ACK codebook including at least one applicability indication associated with at least one HARQ-ACK of the first sidelink HARQ feedback information, the at least one applicability indication indicating whether the at least one HARQ-ACK is associated with the applicable sidelink offset value or the inapplicable sidelink offset value.

The reception component 1602 may receive a resource allocation comprising an allocation of retransmission resources based on the at least one applicability indication. The reception component 1602 may receive second DCI that includes a resource allocation associated with at least one additional sidelink transmission, wherein the second uplink HARQ feedback information includes at least one additional HARQ-ACK associated with the at least one additional sidelink transmission.

The number and arrangement of components shown in FIG. 16 are provided as an example. In practice, there may be additional components, fewer components, different components, or differently arranged components than those shown in FIG. 16. Furthermore, two or more components shown in FIG. 16 may be implemented within a single component, or a single component shown in FIG. 16 may be implemented as multiple, distributed components. Additionally, or alternatively, a set of (one or more) components shown in FIG. 16 may perform one or more functions described as being performed by another set of components shown in FIG. 16.

FIG. 17 is a diagram of an example apparatus 1700 for wireless communication, in accordance with the present disclosure. The apparatus 1700 may be a network node, or a network node may include the apparatus 1700. In some aspects, the apparatus 1700 includes a reception component 1702, a transmission component 1704, and/or a communication manager 1706, which may be in communication with one another (for example, via one or more buses and/or one or more other components). In some aspects, the communication manager 1706 is the communication manager 150 described in connection with FIG. 1. As shown, the apparatus 1700 may communicate with another apparatus 1708, such as a UE or a network node (such as a CU, a DU, an RU, or a base station), using the reception component 1702 and the transmission component 1704.

In some aspects, the apparatus 1700 may be configured to perform one or more operations described herein in connection with FIGS. 7A-7D. Additionally, or alternatively, the apparatus 1700 may be configured to perform one or more processes described herein, such as process 900 of FIG. 9, process 1100 of FIG. 11, process 1300 of FIG. 13, process 1500 of FIG. 15, or a combination thereof. In some aspects, the apparatus 1700 and/or one or more components shown in FIG. 17 may include one or more components of the network node described in connection with FIG. 2. Additionally, or alternatively, one or more components shown in FIG. 17 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1702 may receive communications, such as reference signals, control information, data communications, or a combination thereof, from the apparatus 1708. The reception component 1702 may provide received communications to one or more other components of the apparatus 1700. In some aspects, the reception component 1702 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1700. In some aspects, the reception component 1702 may include one or more antennas, a modem, a demodulator, a MIMO detector, a receive processor, a controller/processor, a memory, or a combination thereof, of the network node described in connection with FIG. 2. In some aspects, the reception component 1702 and/or the transmission component 1704 may include or may be included in a network interface. The network interface may be configured to obtain and/or output signals for the apparatus 1700 via one or more communications links, such as a backhaul link, a midhaul link, and/or a fronthaul link.

The transmission component 1704 may transmit communications, such as reference signals, control information, data communications, or a combination thereof, to the apparatus 1708. In some aspects, one or more other components of the apparatus 1700 may generate communications and may provide the generated communications to the transmission component 1704 for transmission to the apparatus 1708. In some aspects, the transmission component 1704 may perform signal processing on the generated communications (such as filtering, amplification, modulation, digital-to-analog conversion, multiplexing, interleaving, mapping, or encoding, among other examples), and may transmit the processed signals to the apparatus 1708. In some aspects, the transmission component 1704 may include one or more antennas, a modem, a modulator, a transmit MIMO processor, a transmit processor, a controller/processor, a memory, or a combination thereof, of the network node described in connection with FIG. 2. In some aspects, the transmission component 1704 may be co-located with the reception component 1702 in a transceiver.

The communication manager 1706 may support operations of the reception component 1702 and/or the transmission component 1704. For example, the communication manager 1706 may receive information associated with configuring reception of communications by the reception component 1702 and/or transmission of communications by the transmission component 1704. Additionally, or alternatively, the communication manager 1706 may generate and/or provide control information to the reception component 1702 and/or the transmission component 1704 to control reception and/or transmission of communications.

The transmission component 1704 may transmit first control information comprising a first sidelink HARQ timing offset configuration indication that indicates an enabled state of an inapplicable sidelink offset value that is not applicable for indicating a timing for transmitting sidelink HARQ feedback information. The transmission component 1704 may transmit second control information comprising a second sidelink HARQ timing offset configuration indication that indicates a disabled state of the inapplicable sidelink offset value. The reception component 1702 may receive, via an uplink control channel and based on the second control information, uplink HARQ feedback information comprising first sidelink HARQ feedback information associated with a first sidelink transmission and second sidelink HARQ feedback information associated with a second sidelink transmission, the uplink HARQ feedback information comprising the first sidelink HARQ feedback information based on the first control information.

The transmission component 1704 may transmit, to a UE, first control information comprising an uplink HARQ timing offset indication having an applicable uplink offset value that is applicable for indicating a timing for transmitting uplink HARQ feedback information. The reception component 1702 may receive, from the UE and based on the first control information, uplink HARQ feedback information comprising first sidelink HARQ feedback information, the uplink HARQ feedback information comprising the first sidelink HARQ feedback information based on first sidelink control information comprising a first sidelink HARQ timing offset indication having, based on a feedback time period between a sidelink feedback resource associated with receipt of the first sidelink HARQ feedback information and an uplink control channel resource associated with transmission of the uplink HARQ feedback information, an applicable sidelink offset value that is applicable for indicating a timing for transmitting sidelink HARQ feedback information, or second SCI comprising a second sidelink HARQ timing offset indication having an applicable sidelink offset value. The transmission component 1704 may transmit configuration information that indicates the timing threshold.

The transmission component 1704 may transmit, to a UE, first control information indicating a first uplink control channel resource associated with transmission of first uplink HARQ feedback information. The reception component 1702 may receive, from the UE, first uplink HARQ feedback information comprising first sidelink HARQ feedback information associated with a first sidelink transmission, the first uplink HARQ feedback information further comprising a negative HARQ acknowledgment associated with second sidelink HARQ feedback information associated with a second sidelink transmission and based on the UE not receiving the second sidelink HARQ feedback information prior to occurrence of a first time associated with a first uplink control channel resource allocated for transmission of the first uplink HARQ feedback information. The transmission component 1704 may transmit second control information indicating a second uplink control channel resource. The reception component 1702 may receive, based on the second control information, second uplink HARQ feedback information comprising the second sidelink HARQ feedback information.

The reception component 1702 may receive, via an uplink control channel, first uplink HARQ feedback information comprising first sidelink HARQ feedback information associated with at least one sidelink transmission, the first uplink HARQ feedback information comprising a HARQ-ACK codebook including at least one applicability indication associated with at least one HARQ-ACK of the first sidelink HARQ feedback information, the at least one applicability indication indicating whether the at least one HARQ-ACK is associated with an inapplicable sidelink offset value that is not applicable for indicating a timing for transmitting sidelink HARQ feedback information or an applicable sidelink offset value that is applicable for indicating a timing for transmitting sidelink HARQ feedback information. The transmission component 1704 may transmit a resource allocation comprising an allocation of retransmission resources based on the at least one applicability indication. The transmission component 1704 may transmit second DCI that includes a resource allocation associated with at least one additional sidelink transmission, wherein the second uplink HARQ feedback information includes at least one additional HARQ-ACK associated with the at least one additional sidelink transmission.

The number and arrangement of components shown in FIG. 17 are provided as an example. In practice, there may be additional components, fewer components, different components, or differently arranged components than those shown in FIG. 17. Furthermore, two or more components shown in FIG. 17 may be implemented within a single component, or a single component shown in FIG. 17 may be implemented as multiple, distributed components. Additionally, or alternatively, a set of (one or more) components shown in FIG. 17 may perform one or more functions described as being performed by another set of components shown in FIG. 17.

The following provides an overview of some Aspects of the present disclosure:

Aspect 1: A method of wireless communication performed by a user equipment (UE), comprising: receiving first control information comprising a first sidelink hybrid automatic repeat request (HARQ) timing offset configuration indication that indicates a state of an inapplicable sidelink offset value that is not applicable for indicating a timing for transmitting sidelink HARQ feedback information; and transmitting a first sidelink transmission including first sidelink control information (SCI) comprising a first sidelink HARQ timing offset indication for transmission of first sidelink HARQ feedback information associated with the first sidelink transmission, the first sidelink HARQ timing offset indication comprising, based on the first sidelink HARQ timing offset configuration indication, the inapplicable sidelink offset value or an applicable sidelink offset value that is applicable for indicating a timing for transmitting sidelink HARQ feedback information.

Aspect 2: The method of Aspect 1, wherein receiving the first control information comprises receiving first downlink control information.

Aspect 3: The method of either of claims 1 or 2, wherein the first sidelink HARQ timing offset configuration includes an uplink HARQ timing offset indication.

Aspect 4: The method of Aspect 3, wherein the uplink HARQ timing offset indication has an applicable uplink offset value that is applicable for indicating a timing for transmitting uplink HARQ feedback information, and wherein the first sidelink HARQ timing offset indication comprises the applicable sidelink offset value based on the uplink HARQ timing offset indication having the applicable uplink offset value.

Aspect 5: The method of Aspect 4, further comprising: receiving the first sidelink HARQ feedback information based on the first sidelink HARQ timing offset indication comprising the applicable sidelink offset value; and transmitting, via an uplink control channel and based on the first control information, uplink HARQ feedback information comprising the first sidelink HARQ feedback information.

Aspect 6: The method of Aspect 3, wherein the uplink HARQ timing offset indication has an inapplicable uplink offset value that is not applicable for indicating a timing for transmitting uplink HARQ feedback information, and wherein the first sidelink HARQ timing offset indication comprises the inapplicable sidelink offset value based on the uplink HARQ timing offset indication having the inapplicable uplink offset value.

Aspect 7: The method of Aspect 6, further comprising: receiving second control information comprising a second sidelink HARQ timing offset configuration indication that indicates a disabled state of the inapplicable sidelink offset value; receiving the first sidelink HARQ feedback information based on the second sidelink HARQ timing offset configuration indication indicating the disabled state of the inapplicable sidelink offset value; and transmitting, via an uplink control channel and based on the second control information, uplink HARQ feedback information comprising the first sidelink HARQ feedback information and second sidelink HARQ feedback information associated with a second sidelink transmission, the uplink HARQ feedback information comprising the first sidelink HARQ feedback information based on the first control information.

Aspect 8: The method of Aspect 7, wherein receiving the second control information comprises receiving second downlink control information.

Aspect 9: The method of either of Aspects 7 or 8, wherein the second sidelink HARQ timing offset configuration comprises a second uplink HARQ timing offset indication having an applicable uplink offset value that is applicable for indicating a timing for transmitting the uplink HARQ feedback information.

Aspect 10: The method of Aspect 9, wherein transmitting the first sidelink transmission including the first SCI comprises transmitting the first SCI to a receiving UE, the method further comprising transmitting, to the receiving UE based on receiving the second control information, second SCI comprising a second sidelink HARQ timing offset indication for transmission of second sidelink HARQ feedback information associated with a second sidelink transmission, the second sidelink HARQ timing offset indication comprising, based on the second uplink HARQ timing offset indication having the applicable uplink offset value, an applicable sidelink offset value.

Aspect 11: A method of wireless communication performed by a network node, comprising: transmitting first control information comprising a first sidelink hybrid automatic repeat request (HARQ) timing offset configuration indication that indicates an enabled state of an inapplicable sidelink offset value that is not applicable for indicating a timing for transmitting sidelink HARQ feedback information; transmitting second control information comprising a second sidelink HARQ timing offset configuration indication that indicates a disabled state of the inapplicable sidelink offset value; and receiving, via an uplink control channel and based on the second control information, uplink HARQ feedback information comprising first sidelink HARQ feedback information associated with a first sidelink transmission and second sidelink HARQ feedback information associated with a second sidelink transmission, the uplink HARQ feedback information comprising the first sidelink HARQ feedback information based on the first control information.

Aspect 12: The method of Aspect 11, wherein transmitting the first control information comprises transmitting first downlink control information (DCI).

Aspect 13: The method of Aspect 12, wherein transmitting the second control information comprises transmitting second DCI.

Aspect 14: The method of any of Aspects 11-13, wherein the second sidelink HARQ timing offset configuration comprises a second uplink HARQ timing offset indication having an applicable uplink offset value that is applicable for indicating a timing for transmitting the uplink HARQ feedback information.

Aspect 15: A method of wireless communication performed by a user equipment (UE), comprising: transmitting a first sidelink transmission including first sidelink control information (SCI) comprising a first sidelink hybrid automatic repeat request (HARQ) timing offset indication for transmission of first sidelink HARQ feedback information associated with the first sidelink transmission, the first sidelink HARQ timing offset indication comprising, based on a feedback time period between a sidelink feedback resource associated with receipt of the first sidelink HARQ feedback information and an uplink control channel resource associated with transmission of uplink HARQ feedback information, an inapplicable sidelink offset value that is not applicable for indicating a timing for transmitting sidelink HARQ feedback information or an applicable sidelink offset value that is applicable for indicating a timing for transmitting sidelink HARQ feedback information; and receiving the first sidelink HARQ feedback information based on the first SCI or second SCI comprising a second sidelink HARQ timing offset indication having an applicable sidelink offset value.

Aspect 16: The method of Aspect 15, further comprising: receiving first control information comprising an uplink HARQ timing offset indication having an applicable uplink offset value that is applicable for indicating a timing for transmitting uplink HARQ feedback information; and transmitting, based on the first control information and based on receiving the first sidelink HARQ feedback information, uplink HARQ feedback information comprising the first sidelink HARQ feedback information.

Aspect 17: The method of Aspect 16, wherein the first sidelink HARQ timing offset indication comprises the inapplicable sidelink offset value based on the feedback time period satisfying a timing threshold.

Aspect 18: The method of Aspect 17, further comprising receiving configuration information that indicates the timing threshold.

Aspect 19: The method of any of Aspects 16-18, wherein the first sidelink HARQ timing offset indication comprises the applicable sidelink offset value based on the feedback time period failing to satisfy a timing threshold.

Aspect 20: A method of wireless communication performed by a network node, comprising: transmitting, to a user equipment (UE), first control information comprising an uplink hybrid automatic repeat request (HARQ) timing offset indication having an applicable uplink offset value that is applicable for indicating a timing for transmitting uplink HARQ feedback information; and receiving, from the UE and based on the first control information, uplink HARQ feedback information comprising first sidelink HARQ feedback information, the uplink HARQ feedback information comprising the first sidelink HARQ feedback information based on: first sidelink control information (SCI) comprising a first sidelink HARQ timing offset indication having, based on a feedback time period between a sidelink feedback resource associated with receipt of the first sidelink HARQ feedback information and an uplink control channel resource associated with transmission of the uplink HARQ feedback information, an applicable sidelink offset value that is applicable for indicating a timing for transmitting sidelink HARQ feedback information, or second SCI comprising a second sidelink HARQ timing offset indication having an applicable sidelink offset value.

Aspect 21: The method of Aspect 20, wherein the uplink HARQ feedback information comprises the first sidelink HARQ feedback information based on the second SCI comprising a second sidelink HARQ timing offset indication having an applicable sidelink offset value, and wherein the first sidelink HARQ timing offset indication comprises an inapplicable sidelink offset value, that is not applicable for indicating a timing for transmitting sidelink HARQ feedback information, based on the feedback time period satisfying a timing threshold.

Aspect 22: The method of Aspect 21, further comprising transmitting configuration information that indicates the timing threshold.

Aspect 23: The method of any of Aspects 20-22, wherein the uplink HARQ feedback information comprises the first sidelink HARQ feedback information based on the first SCI comprising a first sidelink HARQ timing offset indication having the applicable sidelink offset value, and wherein the first sidelink HARQ timing offset indication comprises the applicable sidelink offset value based on the feedback time period failing to satisfy a timing threshold.

Aspect 24: A method of wireless communication performed by a user equipment (UE), comprising: transmitting a first sidelink transmission including first sidelink control information (SCI) comprising a first sidelink hybrid automatic repeat request (HARQ) timing offset indication for transmission of first sidelink HARQ feedback information associated with a first sidelink transmission and a second sidelink HARQ timing offset indication for transmission of second sidelink HARQ feedback information associated with a second sidelink transmission, the first sidelink HARQ timing offset indication comprising an applicable sidelink offset value that is applicable for indicating a timing for transmitting sidelink HARQ feedback information, and the second sidelink HARQ timing offset indication comprising an inapplicable sidelink offset value that is not applicable for indicating a timing for transmitting sidelink HARQ feedback information; receiving the first sidelink HARQ feedback information; and transmitting, via an uplink control channel, first uplink HARQ feedback information comprising the first sidelink HARQ feedback information, the first uplink HARQ feedback information further comprising a negative HARQ acknowledgment associated with the second sidelink HARQ feedback information based on the UE not receiving the second sidelink HARQ feedback information prior to occurrence of a first time associated with a first uplink control channel resource allocated for transmission of the first uplink HARQ feedback information.

Aspect 25: The method of Aspect 24, further comprising: receiving control information indicating a retransmission resource associated with the negative HARQ acknowledgment; and refraining from performing a retransmission associated with the second sidelink HARQ feedback information based on the UE not receiving the second sidelink HARQ feedback information prior to occurrence of a time associated with the retransmission resource.

Aspect 26: The method of either of claims 24 or 25, further comprising: receiving the second sidelink HARQ feedback information, wherein the second sidelink HARQ feedback information comprises a negative HARQ acknowledgment; and performing a retransmission associated with the negative HARQ acknowledgment based on receiving the second sidelink HARQ feedback information.

Aspect 27: A method of wireless communication performed by a network node, comprising: transmitting, to a user equipment (UE), first control information indicating a first uplink control channel resource associated with transmission of first uplink hybrid automatic repeat request (HARQ) feedback information; and receiving, from the UE, first uplink HARQ feedback information comprising first sidelink HARQ feedback information associated with a first sidelink transmission, the first uplink HARQ feedback information further comprising a negative HARQ acknowledgment associated with second sidelink HARQ feedback information associated with a second sidelink transmission and based on the UE not receiving the second sidelink HARQ feedback information prior to occurrence of a first time associated with a first uplink control channel resource allocated for transmission of the first uplink HARQ feedback information.

Aspect 28: The method of Aspect 27, further comprising: transmitting second control information indicating a second uplink control channel resource; and receiving, based on the second control information, second uplink HARQ feedback information comprising the second sidelink HARQ feedback information.

Aspect 29: A method of wireless communication performed by a user equipment (UE), comprising: transmitting a first sidelink transmission including first sidelink control information (SCI) comprising a first sidelink hybrid automatic repeat request (HARQ) timing offset indication for transmission of first sidelink HARQ feedback information associated with at least one sidelink transmission, the first sidelink HARQ timing offset indication comprising an inapplicable sidelink offset value that is not applicable for indicating a timing for transmitting sidelink HARQ feedback information or an applicable sidelink offset value that is applicable for indicating a timing for transmitting sidelink HARQ feedback information; receiving the first sidelink HARQ feedback information; and transmitting, via an uplink control channel, first uplink HARQ feedback information comprising the first sidelink HARQ feedback information, the first uplink HARQ feedback information comprising a HARQ-acknowledgment (HARQ-ACK) codebook including at least one applicability indication associated with at least one HARQ-ACK of the first sidelink HARQ feedback information, the at least one applicability indication indicating whether the at least one HARQ-ACK is associated with the applicable sidelink offset value or the inapplicable sidelink offset value.

Aspect 30: The method of Aspect 29, wherein the first sidelink HARQ feedback information comprises a HARQ-ACK codebook comprising at least one HARQ-ACK bit, and wherein the at least one applicability indication comprises an applicability bitmap comprising at least one applicability bit, each applicability bit of the at least one applicability bit being associated with a respective HARQ-ACK bit of the at least one HARQ-ACK bit.

Aspect 31: The method of any of Aspects 29-30, wherein the first sidelink HARQ feedback information comprises a HARQ-ACK codebook comprising at least one HARQ-ACK field, each HARQ-ACK field including a combination of two bits of a set of combination options, the set of combination options comprising: a first combination option that indicates an acknowledgment (ACK), a second combination option that indicates a negative acknowledgment (NACK), and a third combination option that indicates a HARQ-ACK associated with the inapplicable sidelink offset value.

Aspect 32: The method of any of Aspects 29-31, further comprising receiving a resource allocation comprising an allocation of retransmission resources based on the at least one applicability indication.

Aspect 33: The method of Aspect 32, wherein the allocation of retransmission resources indicates at least one retransmission resource allocated for retransmission of a sidelink transmission of the at least one sidelink transmission based on the at least one applicability indication indicating that a HARQ-ACK associated with the sidelink transmission is associated with the applicable sidelink offset value.

Aspect 34: The method of any of Aspects 29-33, wherein the at least one applicability indication indicates that the at least one HARQ-ACK is associated with an inapplicable sidelink offset value, the method further comprising: receiving first downlink control information (DCI) that indicates a feedback time period between a sidelink feedback resource associated with receipt of second sidelink HARQ feedback information associated with the inapplicable sidelink offset value and an uplink control channel resource associated with transmission of second uplink HARQ feedback information that includes the second sidelink HARQ feedback information; and transmitting the second uplink HARQ feedback information based on the first DCI.

Aspect 35: The method of Aspect 34, wherein the first DCI comprises a dedicated DCI transmission for indicating the feedback time period.

Aspect 36: The method of either of claims 34 or 35, wherein the first DCI does not include a resource allocation.

Aspect 37: The method of any of Aspects 34-36, wherein the first DCI includes a set of frequency domain resource allocation (FDRA) fields, each FDRA field of the set of FDRA fields including an FDRA value equal to one.

Aspect 38: The method of any of Aspects 34-37, further comprising receiving second DCI that includes a resource allocation associated with at least one additional sidelink transmission, wherein the second uplink HARQ feedback information includes at least one additional HARQ-ACK associated with the at least one additional sidelink transmission.

Aspect 39: A method of wireless communication performed by a network node, comprising: receiving, via an uplink control channel, first uplink hybrid automatic repeat request (HARQ) feedback information comprising first sidelink HARQ feedback information associated with at least one sidelink transmission, the first uplink HARQ feedback information comprising a HARQ-acknowledgment (HARQ-ACK) codebook including at least one applicability indication associated with at least one HARQ-ACK of the first sidelink HARQ feedback information, the at least one applicability indication indicating whether the at least one HARQ-ACK is associated with an inapplicable sidelink offset value that is not applicable for indicating a timing for transmitting sidelink HARQ feedback information or an applicable sidelink offset value that is applicable for indicating a timing for transmitting sidelink HARQ feedback information; and transmitting a resource allocation comprising an allocation of retransmission resources based on the at least one applicability indication.

Aspect 40: The method of Aspect 39, wherein the allocation of retransmission resources indicates at least one retransmission resource allocated for retransmission of a sidelink transmission of the at least one sidelink transmission based on the at least one applicability indication indicating that a HARQ-ACK associated with the sidelink transmission is associated with the applicable sidelink offset value.

Aspect 41: The method of any of Aspects 39-40, wherein the first sidelink HARQ feedback information comprises a HARQ-ACK codebook comprising at least one HARQ-ACK bit, and wherein the at least one applicability indication comprises an applicability bitmap comprising at least one applicability bit, each applicability bit of the at least one applicability bit being associated with a respective HARQ-ACK bit of the at least one HARQ-ACK bit.

Aspect 42: The method of any of Aspects 39-41, wherein the first sidelink HARQ feedback information comprises a HARQ-ACK codebook comprising at least one HARQ-ACK field, each HARQ-ACK field including a combination of two bits of a set of combination options, the set of combination options comprising: a first combination option that indicates an acknowledgment (ACK), a second combination option that indicates a negative acknowledgment (NACK), and a third combination option that indicates a HARQ-ACK associated with the inapplicable sidelink offset value.

Aspect 43: The method of any of Aspects 39-42, wherein the at least one applicability indication indicates that the at least one HARQ-ACK is associated with an inapplicable sidelink offset value, the method further comprising: transmitting first downlink control information (DCI) that indicates a feedback time period between a sidelink feedback resource associated with receipt of second sidelink HARQ feedback information associated with the inapplicable sidelink offset value and an uplink control channel resource associated with transmission of second uplink HARQ feedback information that includes the second sidelink HARQ feedback information; and receiving the second uplink HARQ feedback information based on the first DCI.

Aspect 44: The method of Aspect 43, wherein the first DCI comprises a dedicated DCI transmission for indicating the feedback time period.

Aspect 45: The method of either of claims 43 or 44, wherein the first DCI does not include a resource allocation.

Aspect 46: The method of any of Aspects 43-45, wherein the first DCI includes a set of frequency domain resource allocation (FDRA) fields, each FDRA field of the set of FDRA fields including an FDRA value equal to one.

Aspect 47: The method of any of Aspects 43-46, further comprising transmitting second DCI that includes a resource allocation associated with at least one additional sidelink transmission, wherein the second uplink HARQ feedback information includes at least one additional HARQ-ACK associated with the at least one additional sidelink transmission.

Aspect 48: An apparatus for wireless communication at a device, comprising a processor; memory coupled with the processor; and instructions stored in the memory and executable by the processor to cause the apparatus to perform the method of one or more of Aspects 1-47.

Aspect 49: A device for wireless communication, comprising a memory and one or more processors coupled to the memory, the one or more processors configured to perform the method of one or more of Aspects 1-10.

Aspect 50: An apparatus for wireless communication, comprising at least one means for performing the method of one or more of Aspects 1-10.

Aspect 51: A non-transitory computer-readable medium storing code for wireless communication, the code comprising instructions executable by a processor to perform the method of one or more of Aspects 1-10.

Aspect 52: A non-transitory computer-readable medium storing a set of instructions for wireless communication, the set of instructions comprising one or more instructions that, when executed by one or more processors of a device, cause the device to perform the method of one or more of Aspects 1-10.

Aspect 53: An apparatus for wireless communication at a device, comprising a processor; memory coupled with the processor; and instructions stored in the memory and executable by the processor to cause the apparatus to perform the method of one or more of Aspects 11-14.

Aspect 54: A device for wireless communication, comprising a memory and one or more processors coupled to the memory, the one or more processors configured to perform the method of one or more of Aspects 11-14.

Aspect 55: An apparatus for wireless communication, comprising at least one means for performing the method of one or more of Aspects 11-14.

Aspect 56: A non-transitory computer-readable medium storing code for wireless communication, the code comprising instructions executable by a processor to perform the method of one or more of Aspects 11-14.

Aspect 57: A non-transitory computer-readable medium storing a set of instructions for wireless communication, the set of instructions comprising one or more instructions that, when executed by one or more processors of a device, cause the device to perform the method of one or more of Aspects 11-14.

Aspect 58: An apparatus for wireless communication at a device, comprising a processor; memory coupled with the processor; and instructions stored in the memory and executable by the processor to cause the apparatus to perform the method of one or more of Aspects 15-19.

Aspect 59: A device for wireless communication, comprising a memory and one or more processors coupled to the memory, the one or more processors configured to perform the method of one or more of Aspects 15-19.

Aspect 60: An apparatus for wireless communication, comprising at least one means for performing the method of one or more of Aspects 15-19.

Aspect 61: A non-transitory computer-readable medium storing code for wireless communication, the code comprising instructions executable by a processor to perform the method of one or more of Aspects 15-19.

Aspect 62: A non-transitory computer-readable medium storing a set of instructions for wireless communication, the set of instructions comprising one or more instructions that, when executed by one or more processors of a device, cause the device to perform the method of one or more of Aspects 15-19.

Aspect 63: An apparatus for wireless communication at a device, comprising a processor; memory coupled with the processor; and instructions stored in the memory and executable by the processor to cause the apparatus to perform the method of one or more of Aspects 20-23.

Aspect 64: A device for wireless communication, comprising a memory and one or more processors coupled to the memory, the one or more processors configured to perform the method of one or more of Aspects 20-23.

Aspect 65: An apparatus for wireless communication, comprising at least one means for performing the method of one or more of Aspects 20-23.

Aspect 66: A non-transitory computer-readable medium storing code for wireless communication, the code comprising instructions executable by a processor to perform the method of one or more of Aspects 20-23.

Aspect 67: A non-transitory computer-readable medium storing a set of instructions for wireless communication, the set of instructions comprising one or more instructions that, when executed by one or more processors of a device, cause the device to perform the method of one or more of Aspects 20-23.

Aspect 68: An apparatus for wireless communication at a device, comprising a processor; memory coupled with the processor; and instructions stored in the memory and executable by the processor to cause the apparatus to perform the method of one or more of Aspects 24-26.

Aspect 69: A device for wireless communication, comprising a memory and one or more processors coupled to the memory, the one or more processors configured to perform the method of one or more of Aspects 24-26.

Aspect 70: An apparatus for wireless communication, comprising at least one means for performing the method of one or more of Aspects 24-26.

Aspect 71: A non-transitory computer-readable medium storing code for wireless communication, the code comprising instructions executable by a processor to perform the method of one or more of Aspects 24-26.

Aspect 72: A non-transitory computer-readable medium storing a set of instructions for wireless communication, the set of instructions comprising one or more instructions that, when executed by one or more processors of a device, cause the device to perform the method of one or more of Aspects 24-26.

Aspect 73: An apparatus for wireless communication at a device, comprising a processor; memory coupled with the processor; and instructions stored in the memory and executable by the processor to cause the apparatus to perform the method of one or more of Aspects 27-28.

Aspect 74: A device for wireless communication, comprising a memory and one or more processors coupled to the memory, the one or more processors configured to perform the method of one or more of Aspects 27-28.

Aspect 75: An apparatus for wireless communication, comprising at least one means for performing the method of one or more of Aspects 27-28.

Aspect 76: A non-transitory computer-readable medium storing code for wireless communication, the code comprising instructions executable by a processor to perform the method of one or more of Aspects 27-28.

Aspect 77: A non-transitory computer-readable medium storing a set of instructions for wireless communication, the set of instructions comprising one or more instructions that, when executed by one or more processors of a device, cause the device to perform the method of one or more of Aspects 27-28.

Aspect 78: An apparatus for wireless communication at a device, comprising a processor; memory coupled with the processor; and instructions stored in the memory and executable by the processor to cause the apparatus to perform the method of one or more of Aspects 29-38.

Aspect 79: A device for wireless communication, comprising a memory and one or more processors coupled to the memory, the one or more processors configured to perform the method of one or more of Aspects 29-38.

Aspect 80: An apparatus for wireless communication, comprising at least one means for performing the method of one or more of Aspects 29-38.

Aspect 81: A non-transitory computer-readable medium storing code for wireless communication, the code comprising instructions executable by a processor to perform the method of one or more of Aspects 29-38.

Aspect 82: A non-transitory computer-readable medium storing a set of instructions for wireless communication, the set of instructions comprising one or more instructions that, when executed by one or more processors of a device, cause the device to perform the method of one or more of Aspects 29-38.

Aspect 83: An apparatus for wireless communication at a device, comprising a processor; memory coupled with the processor; and instructions stored in the memory and executable by the processor to cause the apparatus to perform the method of one or more of Aspects 39-47.

Aspect 84: A device for wireless communication, comprising a memory and one or more processors coupled to the memory, the one or more processors configured to perform the method of one or more of Aspects 39-47.

Aspect 85: An apparatus for wireless communication, comprising at least one means for performing the method of one or more of Aspects 39-47.

Aspect 86: A non-transitory computer-readable medium storing code for wireless communication, the code comprising instructions executable by a processor to perform the method of one or more of Aspects 39-47.

Aspect 87: A non-transitory computer-readable medium storing a set of instructions for wireless communication, the set of instructions comprising one or more instructions that, when executed by one or more processors of a device, cause the device to perform the method of one or more of Aspects 39-47.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A user equipment (UE) for wireless communication, comprising:
a memory; and
one or more processors coupled to the memory and configured to cause the UE to:
receive first control information comprising a first sidelink hybrid automatic repeat request (HARQ) timing offset configuration indication that indicates a state of an inapplicable sidelink offset value that is not applicable for indicating a timing for transmitting sidelink HARQ feedback information; and
transmit a first sidelink transmission including first sidelink control information (SCI) comprising a first sidelink HARQ timing offset indication for transmission of first sidelink HARQ feedback information associated with the first sidelink transmission, the first sidelink HARQ timing offset indication comprising, based on the first sidelink HARQ timing offset configuration indication, the inapplicable sidelink offset value or an applicable sidelink offset value that is applicable for indicating a timing for transmitting sidelink HARQ feedback information.

2. The UE of claim 1, wherein the one or more processors, to cause the UE to receive the first control information, are configured to receive first downlink control information.

3. The UE of claim 1, wherein the first sidelink HARQ timing offset configuration includes an uplink HARQ timing offset indication.

4. The UE of claim 3, wherein the uplink HARQ timing offset indication has an applicable uplink offset value that is applicable for indicating a timing for transmitting uplink HARQ feedback information, and wherein the first sidelink HARQ timing offset indication comprises the applicable sidelink offset value based on the uplink HARQ timing offset indication having the applicable uplink offset value.

5. The UE of claim 4, wherein the one or more processors are further configured to cause the UE to:
receive the first sidelink HARQ feedback information based on the first sidelink HARQ timing offset indication comprising the applicable sidelink offset value; and
transmit, via an uplink control channel and based on the first control information, uplink HARQ feedback information comprising the first sidelink HARQ feedback information.

6. The UE of claim 3, wherein the uplink HARQ timing offset indication has an inapplicable uplink offset value that is not applicable for indicating a timing for transmitting uplink HARQ feedback information, and wherein the first sidelink HARQ timing offset indication comprises the inapplicable sidelink offset value based on the uplink HARQ timing offset indication having the inapplicable uplink offset value.

7. The UE of claim 6, wherein the one or more processors are further configured to cause the UE to:
receive second control information comprising a second sidelink HARQ timing offset configuration indication that indicates a disabled state of the inapplicable sidelink offset value;
receive the first sidelink HARQ feedback information based on the second sidelink HARQ timing offset configuration indication indicating the disabled state of the inapplicable sidelink offset value; and
transmit, via an uplink control channel and based on the second control information, uplink HARQ feedback information comprising the first sidelink HARQ feedback information and second sidelink HARQ feedback information associated with a second sidelink transmission, the uplink HARQ feedback information comprising the first sidelink HARQ feedback information based on the first control information.

8. The UE of claim 7, wherein the one or more processors, to cause the UE to receive the second control information, are configured to cause the UE to receive second downlink control information.

9. The UE of claim 7, wherein the second sidelink HARQ timing offset configuration comprises a second uplink HARQ timing offset indication having an applicable uplink offset value that is applicable for indicating a timing for transmitting the uplink HARQ feedback information.

10. The UE of claim 9, wherein the one or more processors, to cause the UE to transmit the first sidelink transmission, are configured to cause the UE to the first SCI comprises transmitting the first SCI to a receiving UE, and wherein the one or more processors are further configured to cause the UE to transmit, to the receiving UE based on receiving the second control information, second SCI comprising a second sidelink HARQ timing offset indication for transmission of second sidelink HARQ feedback information associated with a second sidelink transmission, the second sidelink HARQ timing offset indication comprising, based on the second uplink HARQ timing offset indication having the applicable uplink offset value, an applicable sidelink offset value.

11. A user equipment (UE) for wireless communication, comprising:
a memory; and
one or more processors coupled to the memory and configured to cause the UE to:
transmit a first sidelink transmission including first sidelink control information (SCI) comprising a first sidelink hybrid automatic repeat request (HARQ) timing offset indication for transmission of first sidelink HARQ feedback information associated with the first sidelink transmission, the first sidelink HARQ timing offset indication comprising, based on a feedback time period between a sidelink feedback resource associated with receipt of the first sidelink HARQ feedback information and an uplink control channel resource associated with transmission of uplink HARQ feedback information, an inapplicable sidelink offset value that is not applicable for indicating a timing for transmitting sidelink HARQ feedback information or an applicable sidelink offset value that is applicable for indicating a timing for transmitting sidelink HARQ feedback information; and
receive the first sidelink HARQ feedback information based on the first SCI or second SCI comprising a second sidelink HARQ timing offset indication having an applicable sidelink offset value.

12. The UE of claim 11, wherein the one or more processors are further configured to cause the UE to:
receive first control information comprising an uplink HARQ timing offset indication having an applicable uplink offset value that is applicable for indicating a timing for transmitting uplink HARQ feedback information; and
transmit, based on the first control information and based on receiving the first sidelink HARQ feedback information, uplink HARQ feedback information comprising the first sidelink HARQ feedback information.

13. The UE of claim 12, wherein the first sidelink HARQ timing offset indication comprises the inapplicable sidelink offset value based on the feedback time period satisfying a timing threshold.

14. The UE of claim 13, wherein the one or more processors are further configured to cause the UE to receive configuration information that indicates the timing threshold.

15. The UE of claim 12, wherein the first sidelink HARQ timing offset indication comprises the applicable sidelink offset value based on the feedback time period failing to satisfy a timing threshold.

16. A user equipment (UE) for wireless communication, comprising:
a memory; and
one or more processors coupled to the memory and configured to cause the UE to:
transmit a first sidelink transmission including first sidelink control information (SCI) comprising a first sidelink hybrid automatic repeat request (HARQ) timing offset indication for transmission of first sidelink HARQ feedback information associated with a first sidelink transmission and a second sidelink HARQ timing offset indication for transmission of second sidelink HARQ feedback information associated with a second sidelink transmission, the first sidelink HARQ timing offset indication comprising an applicable sidelink offset value that is applicable for indicating a timing for transmitting sidelink HARQ feedback information, and the second sidelink HARQ timing offset indication comprising an inapplicable sidelink offset value that is not applicable for indicating a timing for transmitting sidelink HARQ feedback information; receive the first sidelink HARQ feedback information; and
transmit, via an uplink control channel, first uplink HARQ feedback information comprising the first sidelink HARQ feedback information, the first uplink HARQ feedback information further comprising a negative HARQ acknowledgment associated with the second sidelink HARQ feedback information based on the UE not receiving the second sidelink HARQ feedback information prior to occurrence of a first time associated with a first uplink control channel resource allocated for transmission of the first uplink HARQ feedback information.

17. The UE of claim 16, wherein the one or more processors are further configured to cause the UE to:
receive control information indicating a retransmission resource associated with the negative HARQ acknowledgment; and
refrain from performing a retransmission associated with the second sidelink HARQ feedback information based on the UE not receiving the second sidelink HARQ feedback information prior to occurrence of a time associated with the retransmission resource.

18. The UE of claim 16, wherein the one or more processors are further configured to cause the UE to:
receive the second sidelink HARQ feedback information, wherein the second sidelink HARQ feedback information comprises a negative HARQ acknowledgment; and
perform a retransmission associated with the negative HARQ acknowledgment based on receiving the second sidelink HARQ feedback information.

19-28. (canceled)
